(19) United States
(12) Patent Application Publication
(10) Pub. No.: US 2018/0300450 A1
(43) Pub. Date: Oct. 18, 2018

(54) SYSTEMS AND METHODS FOR PERFORMING AND OPTIMIZING PERFORMANCE OF DNA-BASED NONINVASIVE PRENATAL SCREENS

(71) Applicant: Counsyl, Inc., South San Francisco, CA (US)

(72) Inventors: Gregory John Hogan, San Francisco, CA (US); Kristjan Eerik Kaseniit, San Francisco, CA (US); Dale E. Muzzey, San Francisco, CA (US)

(73) Assignee: Counsyl, Inc., South San Francisco, CA (US)

(21) Appl. No.: 15/915,070

(22) Filed: Mar. 8, 2018

Related U.S. Application Data
(60) Provisional application No. 62/529,909, filed on Jul. 7, 2017.
(60) Provisional application No. 62/527,858, filed on Jun. 30, 2017.
(60) Provisional application No. 62/508,265, filed on May 18, 2017.
(60) Provisional application No. 62/486,450, filed on Apr. 17, 2017.

(51) Int. Cl. G06F 19/22; G06F 19/28; G06F 19/24

(52) U.S. Cl. CPC G06F 19/22; G06F 19/24; G06F 19/28

(57) ABSTRACT

A computer-implemented method for optimizing performance of a DNA-based noninvasive prenatal screen includes generating a plurality of synthetic sequencing datasets by, for each of the plurality of synthetic sequencing datasets, (i) generating at least one of a plurality of synthetic copy number variants comprising a synthetic number of copies of at least a portion of a region of interest represented by a synthetic number of sequencing reads from one or more segments within the region of interest, and (ii) modifying a real sequencing dataset, which includes genetic sequencing data from a real test sample comprising maternal and fetal cfDNA, by replacing a number of real sequencing reads from the one or more segments within the region of interest in the real test sample with the synthetic number of sequencing reads. Various other methods and systems are also disclosed.

### CROSS-REFERENCE TO RELATED APPLICATIONS

This application claims the benefit of U.S. Provisional Patent Application No. 62/486,450, filed Apr. 17, 2017 and titled SYSTEMS AND METHODS FOR OPTIMIZING PERFORMANCE OF DNA-BASED NONINVASIVE PRENATAL SCREENS TO REDUCE FALSE ANEUPLOIDY CALLS, U.S. Provisional Patent Application No. 62/508,265, filed May 18, 2017 and titled SYSTEMS AND METHODS FOR PERFORMING AND OPTIMIZING PERFORMANCE OF DNA-BASED NONINVASIVE PRENATAL SCREENS, U.S. Provisional Patent Application No. 62/527,858, filed Jun. 30, 2017 and titled SYSTEMS AND METHODS FOR PERFORMING AND OPTIMIZING PERFORMANCE OF DNA-BASED NONINVASIVE PRENATAL SCREENS, and U.S. Provisional Patent Application No. 62/529,909, filed Jul. 7, 2017 and titled SYSTEMS AND METHODS FOR PERFORMING AND OPTIMIZING PERFORMANCE OF DNA-BASED NONINVASIVE PRENATAL SCREENS, the disclosure of each of which is incorporated by reference herein in its entirety.

### BACKGROUND

Circulating throughout the bloodstream of a pregnant woman and separate from cellular tissue are small pieces of deoxyribonucleic acid (DNA), often referred to as cell-free DNA (cfDNA). The cfDNA in the maternal bloodstream includes cfDNA from both the mother (i.e., maternal cfDNA) and the fetus (i.e., fetal cfDNA). The fetal cfDNA originates from the placental cells undergoing apoptosis, and constitutes up to 30% of the total circulating cfDNA, with the balance originating from the maternal genome.

Recent technological developments have allowed for noninvasive prenatal screening of chromosomal aneuploidy in the fetus by exploiting the presence of fetal cfDNA circulating in the maternal bloodstream. Noninvasive methods relying on cfDNA sampled from the pregnant woman's blood serum are particularly advantageous over chorionic villi sampling or amniocentesis, both of which risk substantial injury and possible pregnancy loss.

Various noninvasive cfDNA-based screening procedures have proven to be useful in positively identifying certain chromosomal abnormalities, including trisomy 21 (i.e., Down syndrome), trisomy 18 (i.e., Edwards syndrome), trisomy 13 (i.e., Patau syndrome), microdeletions, and various other small fetal copy number variations. False-positive rates of detection for these disorders are relatively low with noninvasive cfDNA-based screening. However, a high proportion of all false-positive results in such screenings can be ascribed to copy-number variants in the maternal DNA.

The disclosures of all publications referred to herein are each hereby incorporated herein by reference in their entireties. To the extent that any reference incorporated by references conflicts with the instant disclosure, the instant disclosure shall control.

### SUMMARY

As will be described in greater detail below, the instant disclosure describes various systems and methods for optimizing performance of DNA-based noninvasive prenatal screens to reduce false aneuploidy calls and for performing DNA-based noninvasive prenatal screens.

In one embodiment, a computer-implemented method for optimizing performance of a DNA-based noninvasive prenatal screen may include generating a plurality of synthetic sequencing datasets, each of the plurality of synthetic sequencing datasets representing genetic sequencing data from a sample including maternal and fetal cell-free DNA (cfDNA), by, for each of the plurality of synthetic sequencing datasets, (i) generating at least one of a plurality of synthetic copy number variants including a synthetic number of copies of at least a portion of a region of interest represented by a synthetic number of sequencing reads from one or more segments within the region of interest, and (ii) modifying a real sequencing dataset, which includes genetic sequencing data from a real test sample including maternal and fetal cfDNA, by replacing a number of real sequencing reads from the one or more segments within the region of interest in the real test sample with the synthetic number of sequencing reads. The computer-implemented method may also include calculating a potential impact of each of the plurality of synthetic copy number variants on a fetal chromosomal abnormality call during DNA-based noninvasive prenatal screening based on the plurality of synthetic sequencing datasets.

In some embodiments, the method may further include determining, based on the calculated potential impacts of the plurality of synthetic copy number variants on the fetal chromosomal abnormality calls, at least one threshold feature value utilized in the DNA-based noninvasive prenatal screening to identify likely false fetal chromosomal abnormality calls. The threshold feature value may include a threshold percentage of a chromosome covered by at least one copy number variant. The threshold feature value may additionally or alternatively include a threshold base pair length of at least one copy number variant. A feature value above the threshold feature value may indicate a likely false fetal chromosomal abnormality call. The method may further include calculating a potential impact of each of a plurality of real copy number variants on a fetal chromosomal abnormality call during the DNA-based noninvasive prenatal screening based on a plurality of real sequencing datasets each including genetic sequencing data of a real reference sample including one of the plurality of real copy number variants. In this example, determining the at least one threshold feature value utilized in the DNA-based noninvasive prenatal screening may further include determining the at least one threshold feature value based on the calculated potential impacts of both the plurality of synthetic copy number variants and the plurality of real copy number variants on the fetal chromosomal abnormality calls.

In at least one embodiment, the region of interest may include a chromosome or a selected portion of a chromosome. Calculating the potential impact of each of the plurality of synthetic copy number variants on the fetal chromosomal abnormality call may further include determining a quantity of target sequencing reads in each of the plurality of synthetic sequencing datasets, the target sequencing reads corresponding to identified target sequences. The target sequencing reads may each be mappable to a unique location in a reference genome. The at least one of the plurality of synthetic copy number variants may include a synthetic maternal copy number variant. The at least one of the plurality of synthetic copy number variants may additionally include a synthetic fetal copy number variant.

In some embodiments, calculating the potential impact of each of the plurality of synthetic copy number variants on the fetal chromosomal abnormality call may further include calculating a statistical z-score for each of the plurality of synthetic sequencing datasets. Calculating the potential impact of each of the plurality of synthetic copy number variants on the fetal chromosomal abnormality call may further include calculating a statistical z-score change attributable to at least one of the plurality of synthetic copy number variants. The method may further include correlating each of the calculated statistical z-scores and/or each of the calculated statistical z-score changes to a copy number variant size of the at least one of the plurality of synthetic copy number variants. The method may further include correlating each of the calculated statistical z-scores to a copy number variant type of at least one of the plurality of synthetic copy number variants. Calculating the statistical z-score for each of the plurality of synthetic sequencing datasets may include calculating a statistical z-score for the region of interest in the corresponding synthetic sequencing dataset. In this example, calculating the statistical z-score for the region of interest in the corresponding synthetic sequencing dataset may include calculating an average read count in the region of interest in the corresponding synthetic sequencing dataset.

In at least one embodiment, calculating the statistical z-score for each of the plurality of synthetic sequencing datasets may include calculating a statistical z-score for another region of interest in the corresponding synthetic sequencing dataset. In this example, calculating the statistical z-score for the other region of interest in the corresponding synthetic sequencing dataset may include calculating an average read count in the other region of interest in the corresponding synthetic sequencing dataset. Additionally or alternatively, calculating the statistical z-score for each of the plurality of synthetic sequencing datasets may include determining a number of target sequencing reads in each of a plurality of bins. In this example, calculating the statistical z-score for each of the plurality of synthetic sequencing datasets may further include calculating the statistical z-score based on the average number of target sequencing reads per bin for the plurality of bins.

According to some embodiments, one or more of the plurality of synthetic sequencing datasets may further include sequencing reads from one or more additional segments corresponding to real copy number variants in the respective real test samples. Each of the plurality of synthetic copy number variants may include a deletion or a duplication. The region of interest may include at least a portion of human chromosome 1, 13, 18, 21, or X. In at least one embodiment, calculating the potential impact of each of the plurality of synthetic copy number variants on the fetal chromosomal abnormality call may further include calculating a potential impact of each of the plurality of synthetic copy number variants on a fetal chromosomal abnormality call for a specified chromosome that includes the region of interest during DNA-based noninvasive prenatal screening. Additionally or alternatively, calculating the potential impact of each of the plurality of synthetic copy number variants on the fetal chromosomal abnormality call may further include calculating a potential impact of each of the plurality of synthetic copy number variants on a fetal chromosomal abnormality call for a chromosome that does not include the region of interest during DNA-based noninvasive prenatal screening. In at least one embodiment, the fetal chromosomal abnormality call may include a chromosomal aneuploidy call. The chromosomal aneuploidy call may include a chromosomal trisomy call and/or a chromosomal monosomy call. According to some embodiments, the fetal chromosomal abnormality call may include a chromosomal microdeletion call, and/or a chromosomal microduplication call.

In some embodiments, the synthetic number of sequencing reads from each of the one or more segments within the region of interest may be generated by increasing or decreasing the number of real sequencing reads from the one or more segments within the region of interest in the real test sample in proportion to an integer number of copies of the region of interest in the real test sample. In this example, the number of real sequencing reads from each of the one or more segments within the region of interest in the real test sample may be normalized by dividing the number of real sequencing reads from each segment from the real test sample by an average number of real sequencing reads from a corresponding segment from one or more real reference samples. Additionally or alternatively, the number of real sequencing reads from each of the one or more segments within the region of interest in the real test sample may be normalized by dividing the number of real sequencing reads from each segment from the real test sample by an average number of real sequencing reads from one or more segments within the region of interest in the real test sample. The number of real sequencing reads from each of the one or more segments within the region of interest in the real test sample may be normalized for GC content bias or mappability. In at least one embodiment, the number of real sequencing reads from each of the one or more segments within the region of interest in the real test sample may be normalized by fitting a probability distribution based on random subsampling.

According to some embodiments, the method may further include determining, based on the calculated potential impacts of the plurality of synthetic copy number variants on the fetal chromosomal abnormality calls, robustness of a fetal abnormality caller. In this example, the method may further include modifying the fetal abnormality caller based on the determined robustness of the fetal abnormality caller. Determining the robustness of the fetal abnormality caller may include determining a specificity of the fetal abnormality caller over a range of synthetic copy number variant sizes.

In some embodiments, a method for performing a DNA-based noninvasive prenatal screen on a sample that includes maternal DNA and fetal DNA may include (i) isolating cfDNA fragments from a sample that includes maternal cfDNA and fetal cfDNA, (ii) sequencing each of the cfDNA fragments to obtain a plurality of fragment sequencing reads, (iii) identifying target sequencing reads of the plurality of fragment sequencing reads, the identified target sequencing reads being mappable to specified locations of a reference genome, (iv) determining, out of the identified target sequencing reads, a quantity of target sequencing reads for a region of interest, (v) calculating a statistical z-score for the region of interest based on the quantity of target sequencing reads for the region of interest, (vi) determining whether the calculated statistical z-score for the region of interest is outside of a predetermined z-score range, a calculated statistical z-score outside of the predetermined z-score range representing a positive call for a fetal chromosomal abnormality in the region of interest of the fetal DNA, (vii) determining whether maternal genomic DNA from the individual includes at least one copy number variant, and (viii) determining, when the maternal genomic DNA from the individual is determined to include at least one copy number variant, whether a feature value of the at least one copy number variant is greater than a threshold feature value, a feature value greater than the threshold feature value indicating that a call for the fetal chromosomal abnormality is likely a false call.

According to at least one embodiment, the threshold feature value may include a threshold percentage of a chromosome covered by the at least one copy number variant. In this example, the threshold percentage may include about 8% or more. In some embodiments, the threshold percentage may include between about 8% and about 16% and/or between about 10% and about 14%. In at least one embodiment, the threshold feature value may include a threshold base pair length of the at least one copy number variant. According to some embodiments, the threshold feature value may be determined based on analysis of a plurality of synthetic sequencing datasets each representing genetic sequencing data, each of the plurality of synthetic sequencing datasets being generated by (i) generating at least one of a plurality of synthetic copy number variants including a synthetic number of copies of at least a portion of a specified region of interest represented by a synthetic number of sequencing reads from one or more segments within the specified region of interest, and (ii) modifying a real sequencing dataset that includes genetic sequencing data of a real test sample by replacing a number of real sequencing reads from the one or more segments within the specified region of interest in the real test sample with the synthetic number of sequencing reads. The threshold feature value may be further determined by calculating a potential impact of each of the plurality of synthetic copy number variants on a fetal chromosomal abnormality call during DNA-based noninvasive prenatal screening based on the plurality of synthetic sequencing datasets.

According to some embodiments, the fetal chromosomal abnormality may a chromosomal aneuploidy. In this example, the chromosomal aneuploidy may include a chromosomal trisomy and/or a chromosomal monosomy. In at least one embodiment, the fetal chromosomal abnormality may include at least one of a chromosomal microdeletion and a chromosomal microduplication. The at least one copy number variant may include at least one of a deletion and a duplication. The region of interest may include a chromosome or a selected portion of a chromosome. In some embodiments, the region of interest and the at least one copy number variant may be located in the same chromosome. In at least one embodiment, the region of interest and the at least one copy number variant may be located in different chromosomes. The region of interest may include at least a portion of human chromosome 1, 13, 18, 21, or X.

In at least one embodiment, the method may further include (i) adjusting, when the feature value of the at least one copy number variant is greater than the threshold feature value, a quantity of target sequencing reads in at least one variant region corresponding to the at least one copy number variant to generate an adjusted set of target sequencing reads, (ii) generating an adjusted quantity of target sequencing reads for the region of interest based on the adjusted set of target sequencing reads, (iii) calculating an adjusted statistical z-score for the region of interest based on the adjusted quantity of target sequencing reads, and (iv) determining whether the adjusted statistical z-score for the region of interest is outside of the predetermined z-score range. Generating the adjusted quantity of target sequencing reads for the region of interest may include replacing sequencing reads of the quantity of target sequencing reads in the at least one variant region with the adjusted set of target sequencing reads. Adjusting the quantity of target sequencing reads in the at least one variant region to generate the adjusted set of target sequencing reads may include increasing the number of target sequencing reads in the at least one variant region. Additionally or alternatively, adjusting the quantity of target sequencing reads in the at least one variant region to generate the adjusted set of target sequencing reads may include decreasing the number of target sequencing reads in the at least one variant region. According to some embodiments, adjusting the quantity of target sequencing reads in the at least one variant region to generate the adjusted set of target sequencing reads may include removing target sequencing reads in the at least one variant region.

In some embodiments, determining the quantity of target sequencing reads for the region of interest may include determining a number of target sequencing reads in each of a plurality of bins corresponding to the region of interest. Calculating the statistical z-score for the region of interest based on the quantity of target sequencing reads for the region of interest may include calculating the statistical z-score for the region of interest based on the average number of target sequencing reads per bin for the plurality of bins corresponding to the region of interest. In at least one embodiment, the method may further include (i) calculating, when the feature value of the at least one copy number variant is greater than the threshold feature value, an adjusted statistical z-score for the region of interest, and (ii) determining whether the adjusted statistical z-score for the region of interest is outside of the predetermined z-score range. Calculating the adjusted statistical z-score for the region of interest may include adjusting the calculated statistical z-score based on the feature value of the at least one copy number variant.

According to some embodiments, a method for performing a DNA-based noninvasive prenatal screen on a sample that includes maternal DNA and fetal DNA may include (i) isolating cfDNA fragments from a sample that includes maternal cfDNA and fetal cfDNA, (ii) sequencing each of the cfDNA fragments to obtain a plurality of fragment sequencing reads, (iii) identifying target sequencing reads of the plurality of fragment sequencing reads, the identified target sequencing reads being mappable to specified locations of a reference genome, (iv) analyzing the identified target sequencing reads to determine whether maternal genomic DNA from the individual includes at least one copy number variant, (v) adjusting, when the maternal genomic DNA from the individual is determined to include at least one copy number variant, a quantity of target sequencing reads of the identified target sequencing reads for at least one variant region corresponding to the at least one copy number variant to generate an adjusted set of target sequencing reads, (vi) determining, out of the identified target sequencing reads, a quantity of target sequencing reads for a region of interest, (vii) generating an adjusted quantity of target sequencing reads for the region of interest based on the adjusted set of target sequencing reads, (viii) calculating a statistical z-score for the region of interest based on the adjusted quantity of target sequencing reads for the region of interest, and (ix) determining whether the calculated statistical z-score for the region of interest is outside of a predetermined z-score range, a calculated statistical z-score outside of the predetermined z-score range representing a positive call for a fetal chromosomal abnormality in the region of interest of the fetal DNA.

According to some embodiments, generating the adjusted quantity of target sequencing reads for the region of interest may include replacing sequencing reads of the quantity of target sequencing reads in the at least one variant region with the adjusted set of target sequencing reads. Adjusting the quantity of target sequencing reads in the at least one variant region to generate the adjusted set of target sequencing reads may include increasing the number of target sequencing reads in the at least one variant region. Additionally or alternatively, adjusting the quantity of target sequencing reads in the at least one variant region to generate the adjusted set of target sequencing reads may include decreasing the number of target sequencing reads in the at least one variant region. In at least one embodiment, adjusting the quantity of target sequencing reads in the at least one variant region to generate the adjusted set of target sequencing reads may include removing target sequencing reads in the at least one variant region. In some embodiments, determining the quantity of target sequencing reads for the region of interest may include determining a number of target sequencing reads in each of a plurality of bins corresponding to the region of interest. Calculating the statistical z-score for the region of interest based on the adjusted quantity of target sequencing reads for the region of interest may include calculating the statistical z-score for the region of interest based on the average number of target sequencing reads per bin for the plurality of bins corresponding to the region of interest.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIGS. 1A-1D are diagrams schematically illustrating exemplary maternal sequencing reads and fetal sequencing reads obtained from cfDNA.

FIGS. 2A-2D are graphs illustrating exemplary distributions of observed maternal copy number variants.

FIG. 3 is a diagram illustrating exemplary binned sequencing reads from cfDNA samples.

FIG. 4 is a diagram illustrating exemplary binned sequencing reads from cfDNA samples.

FIG. 5 includes plots illustrating exemplary binned sequencing read counts from cfDNA samples.

FIG. 6 is a block diagram of an exemplary system for optimizing performance of a DNA-based noninvasive prenatal screen.

FIG. 7 is a flow diagram of an exemplary method for optimizing performance of a DNA-based noninvasive prenatal screen.

FIG. 8 is a plot showing exemplary synthetic and real copy number variants corresponding to segments of a chromosome.

FIG. 9 is a block diagram of an exemplary system for performing a DNA-based noninvasive prenatal screen on a sample that includes both maternal DNA and fetal DNA.

FIG. 10 is a flow diagram of an exemplary method for performing a DNA-based noninvasive prenatal screen on a sample that includes both maternal DNA and fetal DNA.

FIG. 11 is a flow diagram of an exemplary method for performing a DNA-based noninvasive prenatal screen on a sample that includes both maternal DNA and fetal DNA.

FIG. 12 is a block diagram of an exemplary computing network capable of implementing one or more of the embodiments described and/or illustrated herein.

FIG. 13 is an exemplary graph of z-scores of observed and synthetic maternal sequence duplications plotted with respect to percentages of corresponding chromosomes occupied by the duplications.

FIG. 14 is a plot showing exemplary adjusted synthetic and real copy number variants corresponding to segments of a chromosome.

FIGS. 15A-15F are plots showing exemplary z-score distributions for synthetic cfDNA samples including maternal copy number variants analyzed using various aneuploidy callers.

FIG. 16 includes plots showing an exemplary real sequencing dataset for a chromosome representing a fetal trisomy prior to and following adjustment of read counts corresponding to a maternal duplication.

FIG. 17 includes plots showing an exemplary synthetic sequencing dataset for a chromosome with no trisomy prior to and following adjustment of read counts corresponding to a maternal duplication.

FIG. 18 includes plots showing an exemplary synthetic sequencing dataset for a chromosome representing a fetal trisomy prior to and following adjustment of read counts corresponding to a maternal deletion.

FIG. 19 includes plots illustrating exemplary binned sequencing read counts from real cfDNA samples having various maternal copy number variants.

FIG. 20 includes plots illustrating exemplary binned sequencing read counts from a real cfDNA sample having a maternal duplication and exemplary binned sequencing read counts from a synthetic cfDNA sample having a synthetic maternal duplication.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for optimizing performance of DNA-based noninvasive prenatal screens to reduce false aneuploidy calls and for performing DNA-based noninvasive prenatal screens. The present disclosure is also generally directed to systems and methods for performing DNA-based noninvasive prenatal screens on samples that include both maternal DNA and fetal DNA.

Noninvasive prenatal screens can be used to determine fetal abnormalities for one or more test chromosomes using cell-free DNA from a test maternal blood sample. The results of screening can, for example, inform a patient's decision whether to pursue invasive diagnostic testing (such as amniocentesis or chronic villus sampling), which has a small (but non-zero) risk of miscarriage. Aneuploidy detection using noninvasive cfDNA analysis is linked to fetal fraction (that is, the proportion of cfDNA in the test maternal sample attributable to fetal origin). Aneuploidy may manifest in noninvasive prenatal screens that rely on a measured test chromosome dosage as a statistical increase or decrease in the count of quantifiable products (such as sequencing reads) that can be attributed to the test chromosome relative to an expected test chromosome dosage (that is, the count of quantifiable products that would be expected if the test chromosome were disomic). Various cfDNA-based noninvasive prenatal screening systems and methods are disclosed, for example, in U.S. Patent Publication No. 2014/0342354 and U.S. Patent Application No. 62/424,303.

Conventional aneuploidy detection may rely on an underlying assumption that the maternal cfDNA in a particular sample includes few or no copy number variants (CNVs) on a given chromosome. Thus, cfDNA samples used in noninvasive prenatal screening are implicitly assumed to include the same proportion of genetic material from the maternal chromosome. However, chromosomes for different individuals typically vary to a lesser or greater extent due to CNVs, including CNVs where one or more genomic regions in the chromosomes are duplicated or deleted. For example, one or more duplications in a particular maternal chromosome belonging to a pregnant woman effectively adds to the length of the maternal chromosome and may likewise increase the proportion of cfDNA derived from the maternal chromosome. Conversely, one or more deletions in a particular maternal chromosome may decrease the proportion of cfDNA derived from the maternal chromosome.

Sequencing of cfDNA from individuals having at least one CNV in a chromosome of interest may result in reads leading to false fetal aneuploidy, microdeletion, and/or microduplication interpretations, particularly considering that the vast majority of cfDNA is maternally derived. The mean amount of fetal DNA in cfDNA samples is 13%, although samples may contain as little as about 2% or as much as about 30% fetal DNA. Because the maternal DNA portion of a cfDNA sample is substantially higher than the fetal DNA portion, the impact of CNVs in the maternal DNA may be significant when analyzing the cfDNA sample. Typically, relatively shorter CNVs will not affect detection results in conventional noninvasive prenatal screening. However, longer CNVs of 250 kb and larger have been predicted to increase false-positive aneuploidy calls by 40-fold or more. See, for example, Snyder et al., N Eng J Med, 372:1639-45 (2015). Recent studies of false-positive calls in noninvasive prenatal screens for trisomies 13, 18, and 21 attributed one-third to one-half of the false-positives to duplications in a portion of maternal chromosome 13, 18, or 21. See, for example, Strom et al., N Eng J Med, 376:188-89 (2017), Chudova et al., NEJM, 375:97-98 (2016). Accordingly, CNVs in maternal DNA, particularly duplications, may be a significant contributor to false-positive calls for aneuploidies, including false-positive calls for trisomies 13, 18, and 21. Deletions in maternal DNA may also contribute to false-negative calls for aneuploidies in noninvasive prenatal screens.

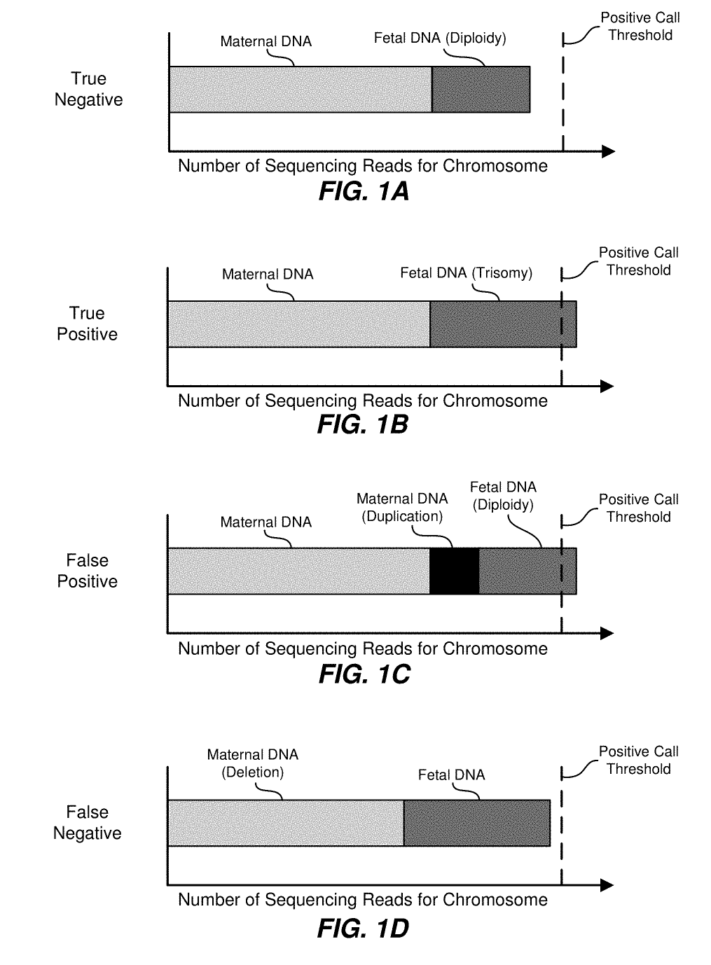

FIGS. 1A-1D schematically illustrate a number of maternal sequencing reads (i.e., quantity of reads contributed by the maternal DNA portion) and a number of fetal sequencing reads (i.e., quantity of reads contributed by the fetal DNA portion) obtained from representative screened cfDNA samples for a specified chromosome. FIGS. 1A and 1B respectively show representations of true-negative and true-positive aneuploidy results from cfDNA screening reads. FIGS. 1C and 1D respectively show representations of false-positive and false-negative aneuploidy results from cfDNA screening reads that are affected by CNVs.

In some embodiments, a noninvasive prenatal screen performed on a cfDNA sample from an individual having a duplication or a deletion in a chromosome of interest in the maternal DNA may result in a false-positive or false-negative fetal aneuploidy, microdeletion, or microduplication call. For example, a maternal sequence duplication may, if large enough, increase a total amount of cfDNA corresponding to a specified chromosome such that, during screening of the cfDNA, the percentage of total sequencing reads corresponding to the specified chromosome is greater than a minimum percentage required to declare a positive result for aneuploidy in the specified chromosome. Often, the percentage of total sequencing reads for the specified chromosome may be used to determine a statistical z-score. A z-score greater than the upper limit of a specified range may result in a positive call for an aneuploidy (e.g., duplication) in the fetal chromosome and a z-score below a lower limit of the specified range may result in a positive call for another type of aneuploidy (e.g., a deletion), while a z-score within the specified range may result in a negative aneuploidy call.

FIG. 1A schematically illustrates sequencing reads obtained by screening a cfDNA sample in which the maternal DNA has no CNVs in the specified chromosome and the fetal DNA includes a diploidy of the specified chromosome. The combined reads counted from the maternal DNA and the fetal DNA does not exceed a threshold count required to make a positive aneuploidy call for the cfDNA sample. Accordingly, the screening result is a true negative call for fetal aneuploidy.

FIG. 1B schematically illustrates sequencing reads obtained by screening a cfDNA sample in which the maternal DNA has no CNVs in the specified chromosome and the fetal DNA includes a trisomy of the specified chromosome. As illustrated in FIG. 1B, the sequencing reads contributed by the fetal DNA are increased in comparison to the diploid fetal DNA shown in FIG. 1A due to the additional fetal cfDNA sequences contributed by the aneuploid fetal chromosome. Owing to the additional reads attributable to the fetal DNA, the combined reads counted from the maternal DNA and the fetal DNA exceeds the threshold count required to make a positive aneuploidy call for the cfDNA sample. Accordingly, the screening result is a true positive call for fetal aneuploidy.

FIG. 1C schematically illustrates sequencing reads obtained by screening a cfDNA sample in which the maternal DNA has a duplication in the specified chromosome and the fetal DNA includes a diploidy of the specified chromosome. As illustrated in FIG. 1C, the sequencing reads contributed by the maternal DNA are increased in comparison to the maternal DNA shown in FIG. 1A, which includes no CNVs, due to the additional maternal cfDNA sequences contributed by the duplicated portion of the maternal DNA. Owing to the additional reads attributable to the duplicated portion of the maternal DNA, the combined reads counted from the maternal DNA and the fetal DNA exceeds the threshold count required to make a positive aneuploidy call for the cfDNA sample. Accordingly, the screening result is a positive call for fetal aneuploidy, albeit a false-positive call since the fetal chromosome is in fact diploid.

FIG. 1D schematically illustrates sequencing reads obtained by screening a cfDNA sample in which the maternal DNA has a deletion in the specified chromosome and the fetal DNA includes a trisomy of the specified chromosome. As illustrated in FIG. 1D, the sequencing reads contributed by the maternal DNA are decreased in comparison to the maternal DNA shown in FIG. 1A, which includes no CNVs, based on the lower number of maternal cfDNA sequences contributed by the maternal DNA due to the deleted portion of the maternal DNA. Even though the number of reads contributed by the fetal DNA is increased based on the trisomy in the specified chromosome, the combined reads counted from the maternal DNA and the fetal DNA does not exceed the threshold count required to make a positive aneuploidy call for the cfDNA sample. Accordingly, the screening result is a false-negative call for fetal aneuploidy since the fetal DNA includes a trisomy of the specified chromosome that is not called due to the influence of the maternal deletion.

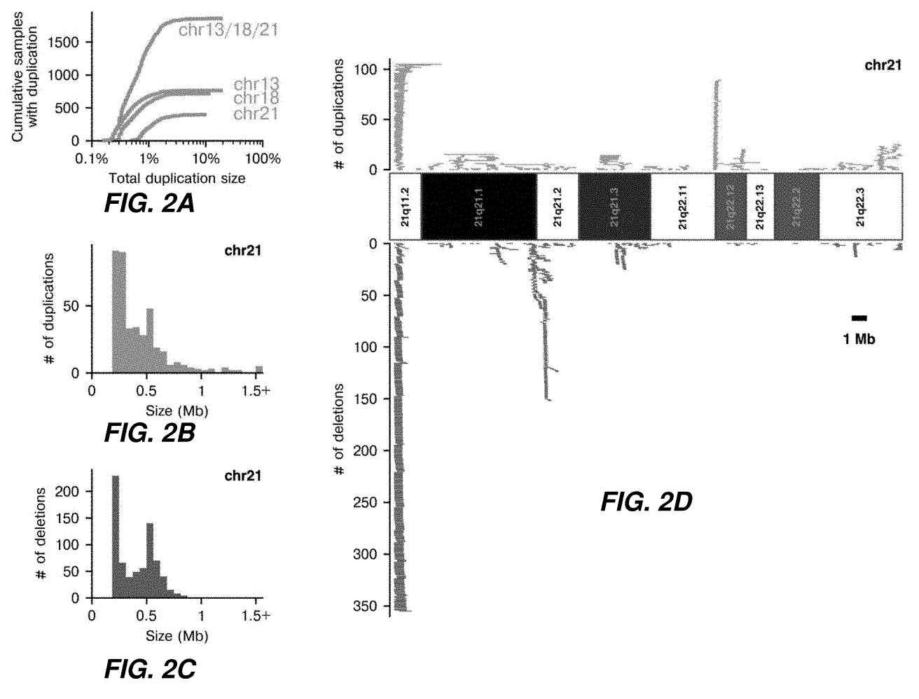

Many maternal CNVs (mCNVs) may not affect the overall sequencing read counts during noninvasive prenatal screening to a degree significant enough to result in a false-positive or negative aneuploidy call, as illustrated in FIGS. 1C and 1D. For example, relatively shorter CNVs, may not affect an aneuploidy call. However, the vast majority of real maternal CNVs are relatively shorter CNVs spanning less than 4% of their respective chromosomes. FIG. 2A shows a cumulative distribution of duplication size (expressed as the percentage of the chromosome the duplications span) for mCNV duplications observed on chromosomes 13, 18, and 21, as well as their aggregate, in 87,255 real samples. FIGS. 2B and 2C show size distributions on chromosome 21 of maternal CNVs (duplications and deletions) observed in the 87,255 real samples. FIG. 2D also shows positions and lengths of mCNVs observed in mappable regions of chromosome 21 of the 87,255 real samples. 99% of maternal duplications in chromosomes 13, 18, or 21 of the 87,255 real samples spanned less than 4% of the respective chromosomes.

Additional factors contributing to whether or not a maternal CNV is likely to influence an aneuploidy call for a particular chromosome include, for example, the size of maternal CNV with respect to the size of the particular chromosome, whether the maternal CNV is located in the particular chromosome, the number of maternal CNVs in the chromosome, the type of maternal CNV, and the fetal DNA fraction in the cfDNA sample. One or more of these factors may be analyzed to determine a potential impact on an aneuploidy call.

In some embodiments, mCNVs may be detected using a moving-window approach that considers copy-number values in bins (e.g., 20 kb bins) tiling each chromosome. A bin's copy-number value may be a fractional number (e.g., 1.997) that reflects the bin's read depth and results from multiple normalization steps described, as described in greater detail below. The presence or absence of an mCNV may be assessed at each bin i. First, the median copy-number value across, for example, 10 bins i through i+9 may be calculated in both a sample of interest and in background samples. A z-score may be computed for each sample's observed median copy-number value relative to the background average. Bins i through i+9 may be classified as part of an mCNV if (1) the absolute median copy-number value is <1.5 or >2.5, and (2) the absolute z-score is determined to be significant. As some genomic bins may be filtered out elsewhere in the analysis pipeline (e.g., for spuriously high read depth or for “unmappable” regions with redundant sequences that complicate unique mapping of reads), gaps of up to, for example, five genomic bins within mCNVs may be allowed. Consecutive mCNV calls of the same type may be merged if the resulting call has a significant z-score. For example a 12-bin mCNV may be called by merging three mCNV calls starting at bins i, i+1 and i+2, or a 25-bin call may be made by merging calls starting at bins i and i+15 (if bins i+10 through i+14 were a gap). The edges of merged calls may be trimmed by up to 10 bins on either side, with the final mCNV boundaries determined by the pair of edges that maximized the absolute z-score of the call. Due to the trimming, calls smaller than 200 kb may be possible if the trimmed set of bins yield a large enough absolute z-score.

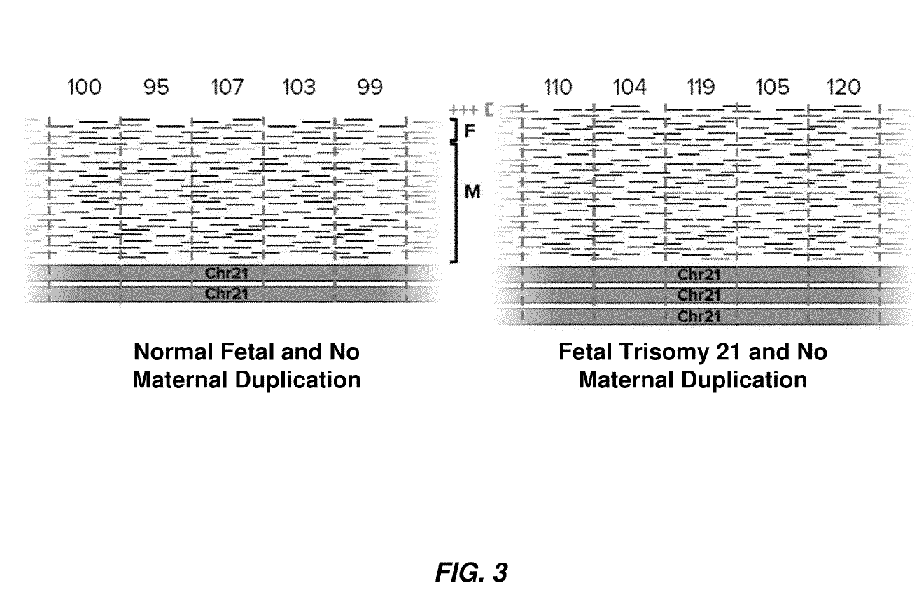

FIGS. 3-5 illustrate how aneuploidies and maternal CNVs may affect sequencing read counts based on a binning approach for grouping and counting sequencing reads. Binning may be used to group and count sequencing reads obtained from cfDNA samples. For example, cfDNA fragments obtained from a sample may be amplified and sequenced and target sequences that are mappable to specified locations in a reference genome may be sorted into bins. The number of target sequences in each bin may then be counted. As shown in FIG. 3, analysis of a cfDNA sample that includes fetal DNA fragments from a fetus having trisomy 21 may show an increased number of sequencing reads in multiple bins from chromosome 21 in comparison to a “normal” cfDNA that includes no maternal CNVs and no fetal aneuploidies or microduplications in chromosome 21.

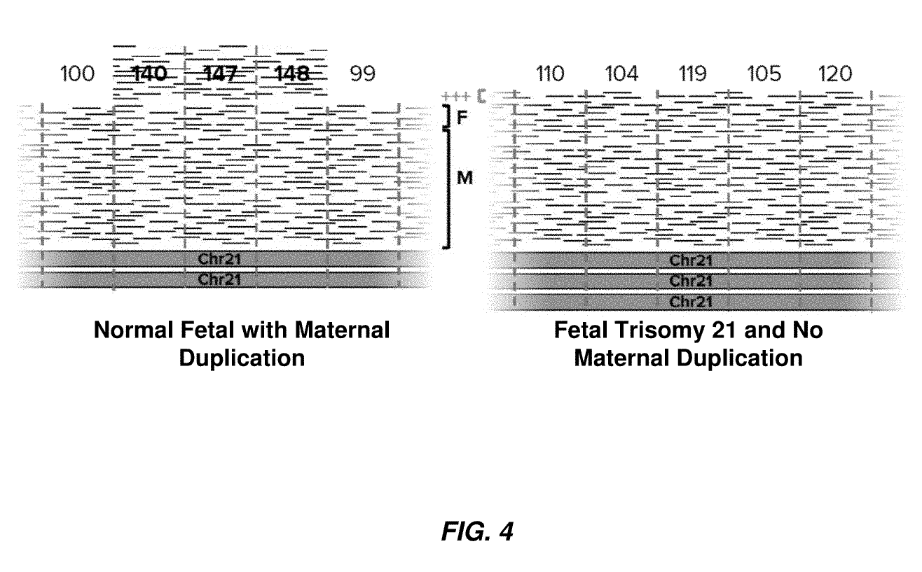

As shown in FIG. 4, a maternal duplication in chromosome 21 may lead to an increase in sequencing reads from a cfDNA sample in certain bins in chromosome 21 corresponding to the duplication, resulting in an increase in sequencing reads for these bins. Because the maternal DNA portion of the cfDNA sample is substantially higher than the fetal DNA portion, the impact of the duplication in the maternal DNA may be significant when analyzing the cfDNA sample, as illustrated in FIG. 4. For example, although the duplication does not affect sequencing read counts in all of the bins for chromosome 21, the impact of the duplication per affected bin is substantially higher than the impact per affected bin for a fetal trisomy. If enough bins in chromosome 21 are affected by the maternal duplication, the average read count per bin may be increased enough to affect a z-score or other value of statistical significance utilized to determine the presence of an aneuploidy or microduplication in chromosome 21. Conversely, a maternal deletion may have an effect of significantly reducing sequencing read counts in each bin affected by the deletion.

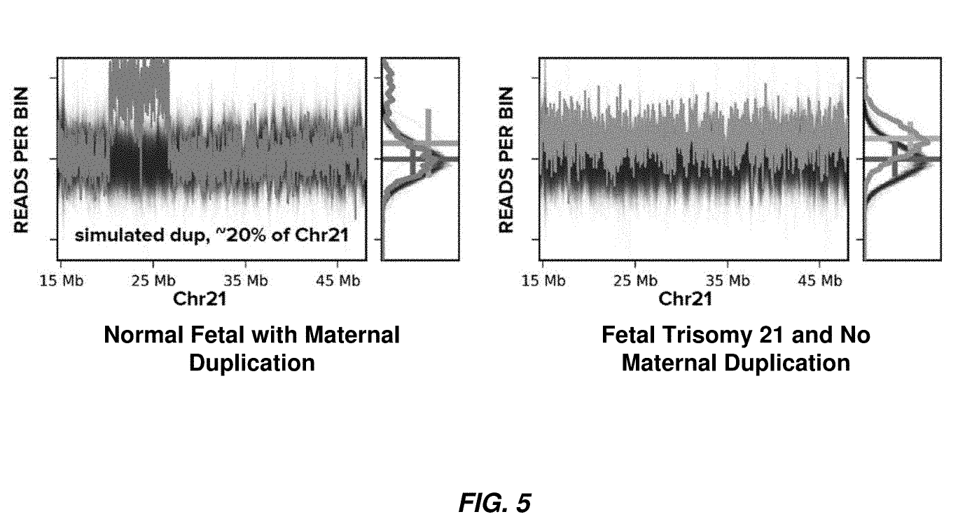

FIG. 5 shows a maternal duplication in chromosome 21 that may significantly affect analysis results for a cfDNA sample during noninvasive prenatal screening. FIG. 5 illustrates binned sequencing read counts for a sample in which a maternal duplication in chromosome 21 (in this case a synthetic duplication generated in accordance with the systems and methods described herein) covers approximately 20% of chromosome 21. A cfDNA sample that includes such a maternal duplication may result in an average read count per bin and calculated z-score for chromosome 21 that approaches or exceeds an average read count per bin and calculated z-score for a cfDNA sample having fetal trisomy 21.

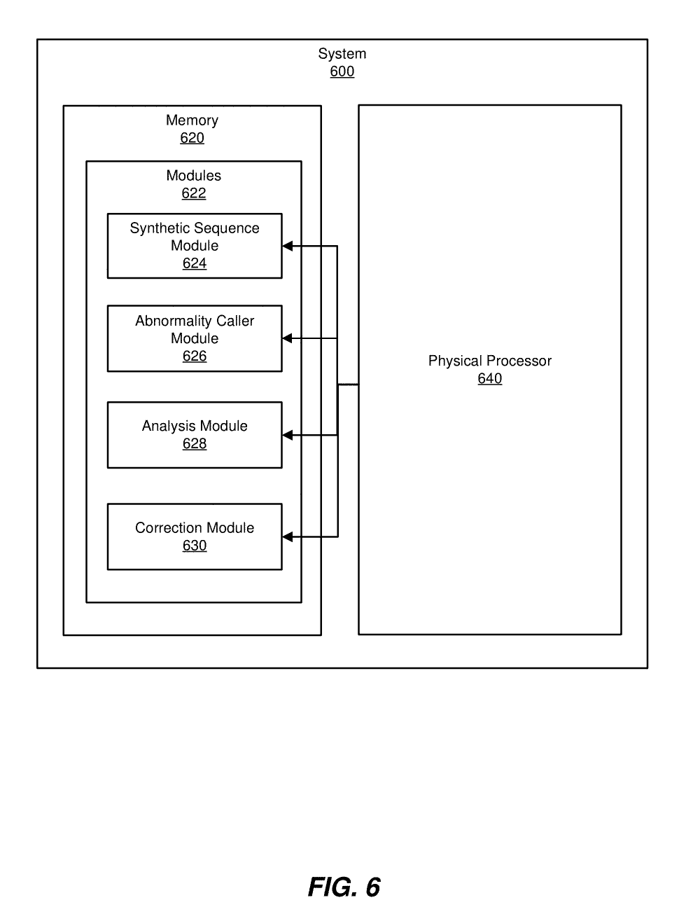

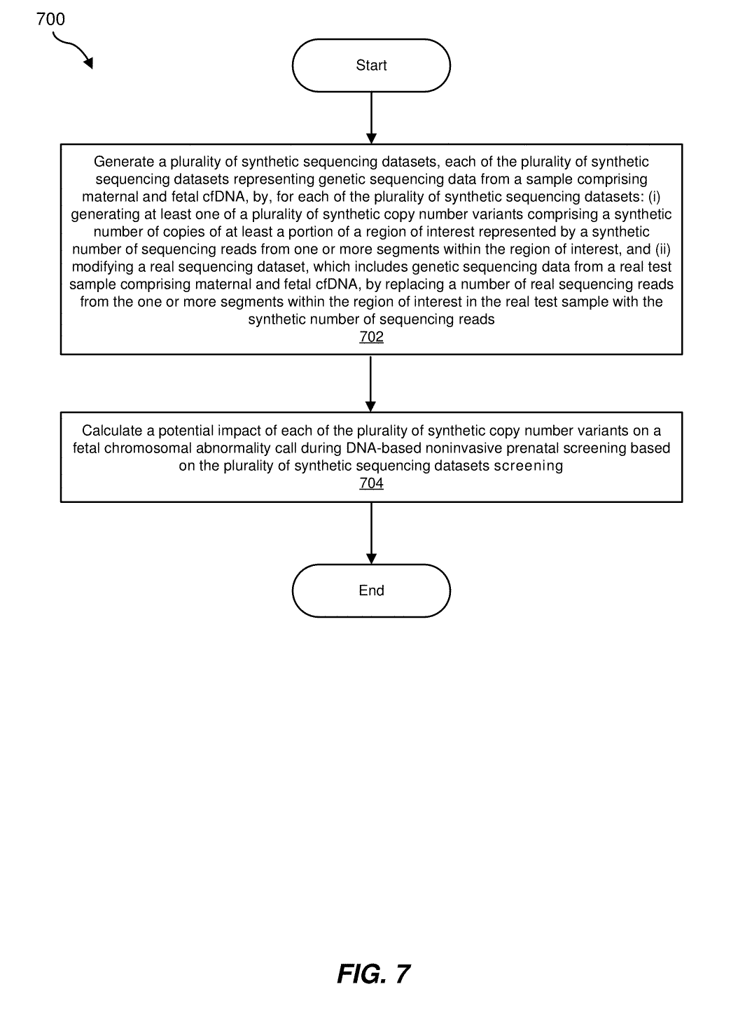

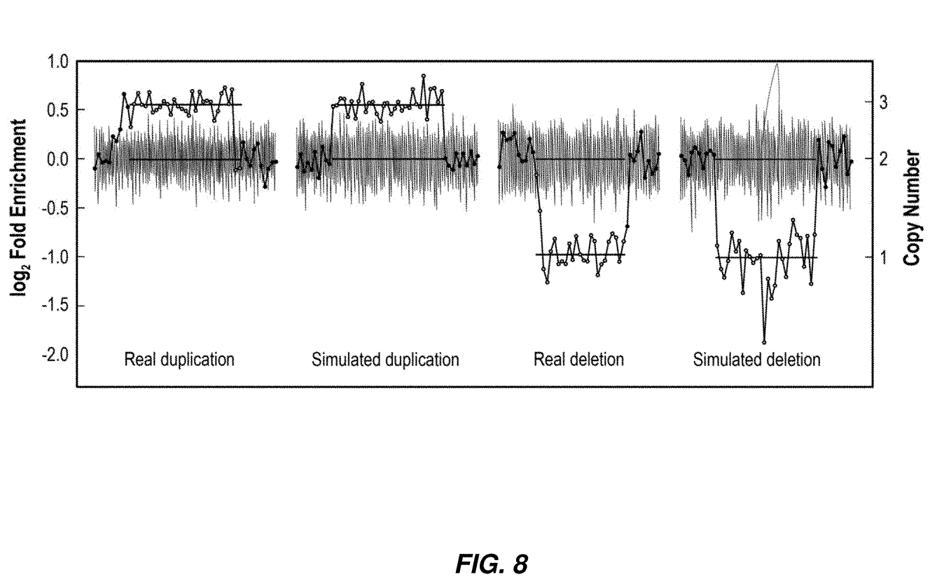

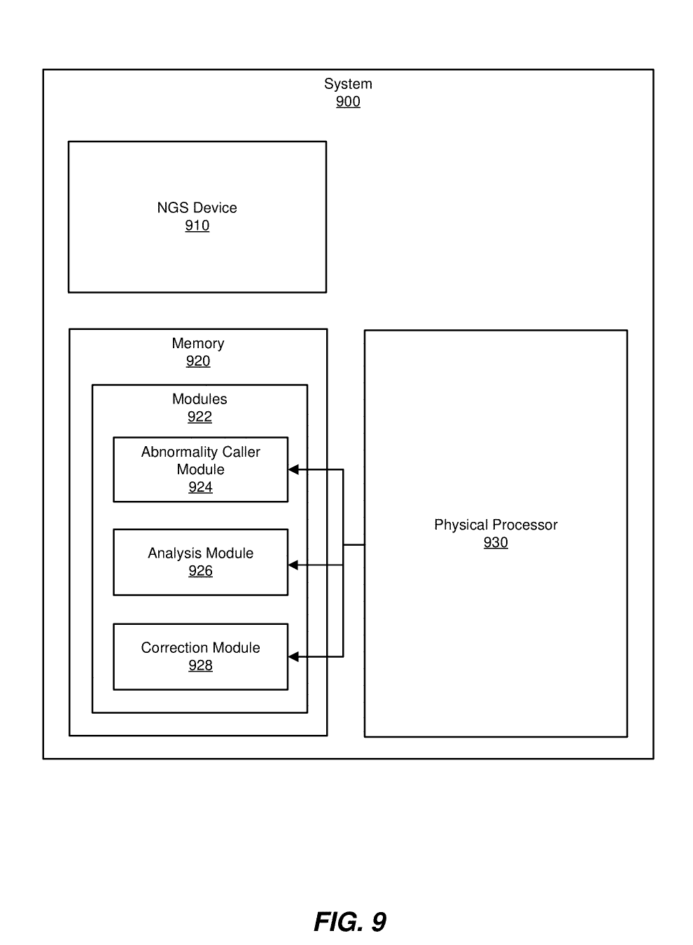

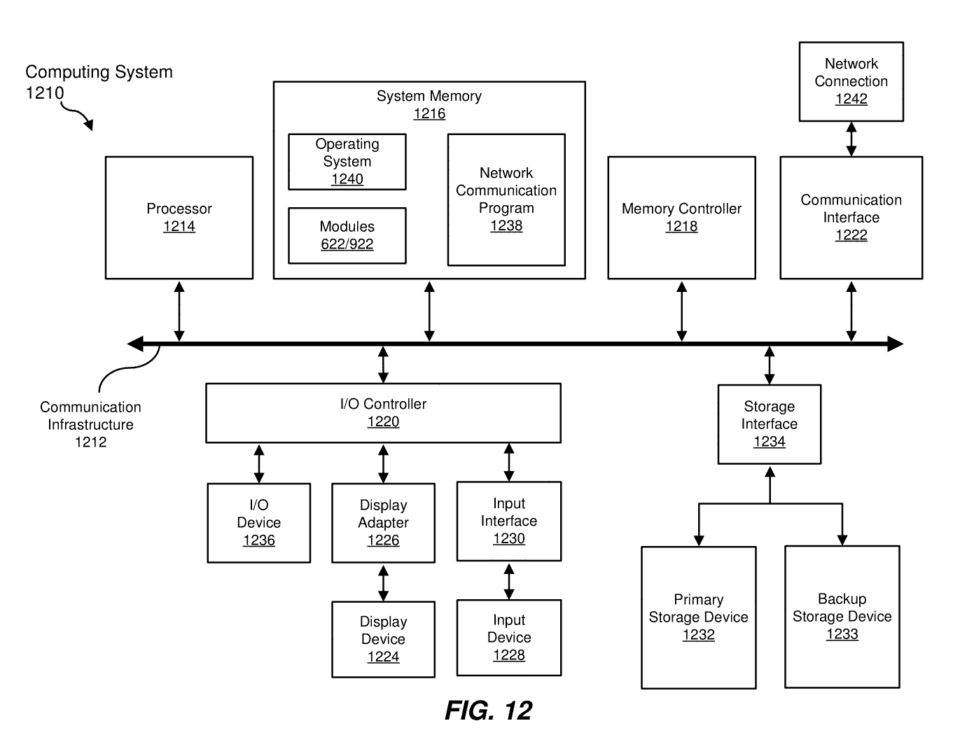

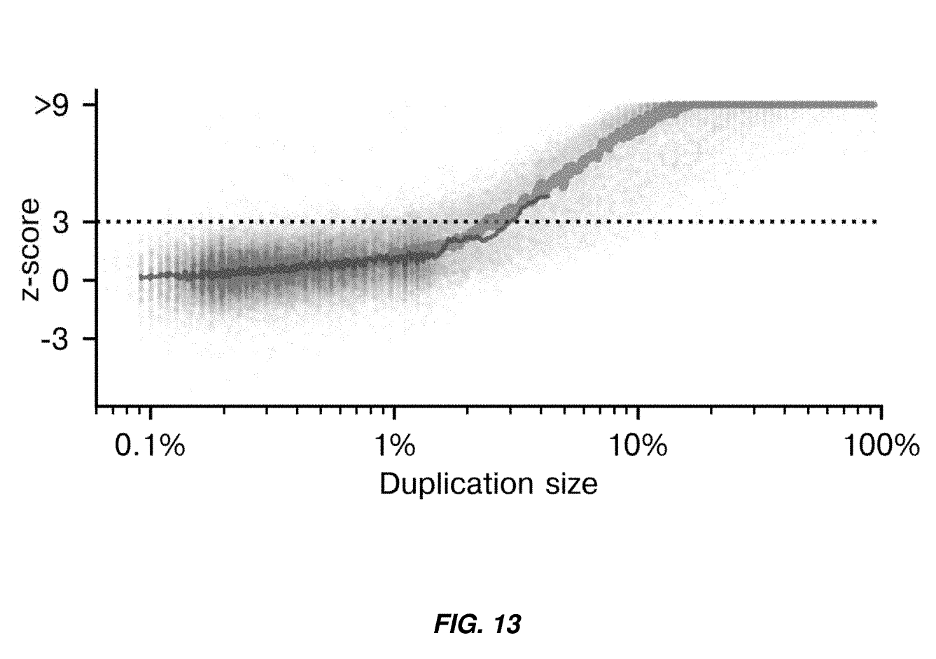

The following will provide, with reference to FIGS. 6 and 9, detailed descriptions of example systems for optimizing performance of DNA-based noninvasive prenatal screens to reduce false aneuploidy calls and example systems for performing a DNA-based noninvasive prenatal screen on a sample that includes both maternal DNA and fetal DNA. Detailed descriptions of corresponding methods will also be respectively provided in connection with FIGS. 7, 10, and 11. Detailed descriptions of exemplary CNVs will be provided in connection with FIG. 8. In addition, detailed descriptions of an example computing system capable of implementing at least a portion of one or more of the embodiments described herein will be provided in connection with FIG. 12. Detailed descriptions of various examples will also be provided in connection with FIGS. 13-20.

Unless defined otherwise herein, all technical and scientific terms used herein have the same meaning as commonly understood by one of ordinary skill in the art to which this invention belongs. Numeric ranges are inclusive of the numbers defining the range.

Reference to “about” a value or parameter herein includes (and describes) variations that are directed to that value or parameter per se. For example, the term “about,” as used herein, may represent plus or minus ten percent (10%) of a value. For example, “about 100” refers to any number between 90 and 110.

The term “average,” as used herein, refers to either a mean or a median, or any value used to approximate the mean or median.

A “bin” is an arbitrary genomic region from which a quantifiable measurement can be made. When multiple bins (i.e., a plurality of bins) are subjected to common analysis, the length of each arbitrary genomic region is preferably the same and tiled across a region of interest without overlaps. Nevertheless, the bins can be of different lengths, and can be tiled across the region of interest with overlaps or gaps.

The term “copy number variant” or “CNV,” as used herein, refers to any duplication or deletion of a region of interest.

The term “deletion,” as used herein, refers to any decrease in the number of copies of a region of interest relative to one or more real reference samples. For example, if the one or more real reference samples have two copies of a region of interest, a deletion can refer to a single copy of the region of interest. If the one or more real reference samples have four copies of a region of interest, a deletion can refer to one, two, or three copies of the region of interest.

The term “duplication,” as used herein, refers to any increase in the number of copies of a region of interest relative to one or more real reference samples, including three or more, four or more, five or more, etc. copies of the region of interest.

A “genetic variant caller,” as used herein, refers to any method or technique (including software) that can be used to identify one or more genetic features. Genetic features that can be identified by a genetic variant caller include, but are not limited to, the copy number of a region of interest, an insertion, a deletion, a translocation, an inversion, or a small nucleotide variant (SNV). An “abnormality caller,” as used herein, refers to any method or technique (including software) that can be used to identify an abnormal number of chromosomes in fetal DNA. For example, an abnormality caller may identify an additional chromosome resulting in a trisomy of the chromosome.

A “mappable” sequencing read, as used herein, refers to a sequencing read that aligns with a unique location in a genome. A sequencing read that maps to zero or two or more locations in the genome is considered not “mappable.”

A “maternal sample,” as used herein, refers to any sample taken from a pregnant mammal which comprises a maternal source and a fetal source of nucleic acids. The term “training maternal sample” refers to a maternal sample that is used to train a machine-learning model.

The term “maternal cell-free DNA” or “maternal cfDNA,” as used herein, refers to cell-free DNA originating from a chromosome from a maternal cell that is neither placental nor fetal. The term “fetal cell-free DNA” or “fetal cfDNA” refers to a cell-free DNA originating from a chromosome from a placental cell or a fetal cell.

The term “normal,” as used herein, when used to characterize a putative fetal chromosomal abnormality, such as a microdeletion, microduplication, or aneuploidy, indicates that the putative fetal chromosomal abnormality is not present. The term “abnormal” when used to characterize a putative fetal chromosomal abnormality indicates that the putative fetal chromosomal abnormality is present.

A “number of sequencing reads,” as used herein, refers to an absolute number of sequencing reads or a normalized number of sequencing reads.

A “real sample,” as used herein, refers to a nucleic acid sequence or sequencing reads originating from a nucleic acid sequence that originates from a physical sample subjected to genetic sequencing without the sequence, sequencing reads, or number of sequencing reads being altered. A “real reference sample” refers to a real sample that is compared to a synthetic sample (e.g., a synthetic copy number variant) by the genetic variant caller. A “real test sample,” as used herein, refers to a real sample that is used to generate the synthetic sample.

A “real sequencing read,” as used herein, refers to a sequencing read that originates from a real sample without alteration of the sequence. A “number of real sequencing reads” refers to an absolute number of real sequencing reads or a normalized number of sequencing reads, but does not refer to a number of sequencing reads that has been altered to reflect an increase in a number of copies of any segment or region of interest and/or portion of a chromosome of interest.

A “segment,” as used herein, refers to a sub-region in a region of interest that serves as a locus of origin for sequencing reads. The segment can be as short as a single base or can be as long as the region of interest. Multiple segments within a region of interest may be, but need not be, continuous, contiguous, or overlapping.

The term “synthetic copy number variant,” as used herein, refers to an artificial nucleic acid sequence generated using real sequencing reads from a real sample with an increase or decrease in the number of copies of a region of interest and/or portion of a chromosome of interest compared to the real sample. The synthetic copy number variant need not be (although, in some embodiments, could be) an aligned or assembled nucleic acid sequence, and can be represented by a synthetic number of sequencing reads (i.e., an absolute number or a normalized number of sequencing reads).

A “synthetic number of copies,” as used herein, refers to the number of copies of a region of interest in the synthetic copy number variant, and can be an increase or decrease in the number of copies relative to the real sample.

A “synthetic number of sequencing reads,” as used herein, refers to a number of real sequencing reads that has been altered to reflect an increase or a decrease in the number of copies of a segment within a region of interest and/or portion of a chromosome of interest. The real sequencing reads originate from the same segment (i.e., originate for a corresponding segment) within the region of interest and/or portion of the chromosome of interest as the sequencing reads in the synthetic number of sequencing reads. The synthetic number of sequencing reads is an absolute number of sequencing reads or a normalized number of sequencing reads.

A “synthetic variant,” as used herein, in a reference genome refers to a variant artificially introduced into a nucleic acid sequence in the reference genome, unless context clearly indicates otherwise. The “inverse” of a synthetic variant refers to the opposite consequence of the synthetic variant that would appear in a nucleic acid sequence when compared to the reference sequence comprising the synthetic variant.

A “variation,” as used herein, refers to any statistical metric that defines the width of a distribution, and can be, but is not limited to, a standard deviation, a variance, or an interquartile range.

A “value of likelihood,” as used herein, refers to any value achieved by directly calculating likelihood or any value that can be correlated to or otherwise indicative of likelihood. The term “value of likelihood” includes an odds ratio.

A “value of statistical significance,” as used herein, is any value that indicates the statistical distance of a tested event or hypothesis from a null or reference hypothesis, such as a z-score, a p-value, or a probability.

A “z-score” (i.e., standard score, z-value, normal score, standardized variable, etc.) as used herein, refers to a number of standard deviations an observation value or data point is from an average value and may refer to an aneuploidy z-score, not a z-score of an mCNV.

It is understood that aspects and variations of the invention described herein include “consisting” and/or “consisting essentially of” aspects and variations.

Where a range of values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Unless otherwise indicated, nucleic acids are written left to right in 5′ to 3′ orientation; amino acid sequences are written left to right in amino to carboxy orientation, respectively.

It is to be understood that one, some or all of the properties of the various embodiments described herein may be combined to form other embodiments of the present invention.

The section headings used herein are for organizational purposes only and are not to be construed as limiting the subject matter described.

The practice of the present invention employs, unless otherwise indicated, conventional techniques of immunology, biochemistry, chemistry, molecular biology, microbiology, cell biology, genomics and recombinant DNA, which are within the skill of the art. See e.g. Sambrook, Fritsch and Maniatis, MOLECULAR CLONING: A LABORATORY MANUAL, 2nd edition (1989); CURRENT PROTOCOLS IN MOLECULAR BIOLOGY (F. M. Ausubel, et al. eds., (1987)); the series METHODS IN ENZYMOLOGY (Academic Press, Inc.): PCR 2: A PRACTICAL APPROACH (M. J. MacPherson, B. D. Hames and G. R. Taylor eds. (1995)), Harlow and Lane, eds. (1988) ANTIBODIES, A LABORATORY MANUAL, and ANIMAL CELL CULTURE (R. I. Freshney, ed. (1987)).

Exemplary computer programs which can be used to determine identity between two sequences include, but are not limited to, the suite of BLAST programs, e.g., BLASTN, BLASTX, and TBLASTX, BLASTP and TBLASTN, and BLAT publicly available on the Internet. See also, Altschul, et al., 1990 and Altschul, et al., 1997.

Sequence searches may be carried out, using any suitable software, without limitation, including, for example, using the BLASTN program when evaluating a given nucleic acid sequence relative to nucleic acid sequences in the GenBank DNA Sequences and other public databases. The BLASTX program is preferred for searching nucleic acid sequences that have been translated in all reading frames against amino acid sequences in the GenBank Protein Sequences and other public databases. Both BLASTN and BLASTX are run using default parameters of an open gap penalty of 11.0, and an extended gap penalty of 1.0, and utilize the BLOSUM-62 matrix. (See, e.g., Altschul, S. F., et al., Nucleic Acids Res. 25:3389-3402, 1997).

Alignment of selected sequences in order to determine “% identity” between two or more sequences, may be performed using any suitable software, without limitation, including, for example, the CLUSTAL-W program in MacVector version 13.0.7, operated with default parameters, including an open gap penalty of 10.0, an extended gap penalty of 0.1, and a BLOSUM 30 similarity matrix.

In some embodiments, targeted sequencing and/or high-depth whole-genome sequencing may be utilized to sequence cfDNA fragments. Any high-throughput quantitative data that reflects the dose of a particular genomic region may be used, be it from next-generation sequencing (NGS), microarrays, or any other high-throughput quantitative molecular biology technique. In at least one embodiment, sequences from a region of interest may be isolated and enriched, where possible, with hybrid-capture probes or PCR primers, which should be designed such that the captured and sequenced fragments contain at least one sequence that distinguishes a gene from its homolog(s). For example, hybrid-capture probes may be designed to anneal adjacent to the few bases that differ between the gene and the homolog(s)/pseudogene(s) (“diff bases”). Where such distinguishing sequence is scarce, multiple probes may be used to capture distinguishable fragments to diminish the effect of biases inherent to each particular probe's sequence. Amplicon sequencing can be used as an alternative to hybrid-capture as a means to achieve targeted sequencing.

In some embodiments, sequences from a region of interest may be isolated with oligonucleotides adhered to a solid support. Oligonucleotides to which the solid support is exposed for attachment may be of any suitable length, and may comprise one or more sequence elements. Examples of sequence elements include, but are not limited to, one or more amplification primer annealing sequences or complements thereof, one or more sequencing primer annealing sequences or complements thereof, one or more common sequences shared among multiple different oligonucleotides or subsets of different oligonucleotides, one or more restriction enzyme recognition sites, one or more target recognition sequences complementary to one or more target polynucleotide sequences, one or more random or near-random sequences (e.g. one or more nucleotides selected at random from a set of two or more different nucleotides at one or more positions, with each of the different nucleotides selected at one or more positions represented in a pool of oligonucleotides comprising the random sequence), one or more spacers, and combinations thereof. Two or more sequence elements can be non-adjacent to one another (e.g. separated by one or more nucleotides), adjacent to one another, partially overlapping, or completely overlapping.

In some embodiments, the oligonucleotide sequence attached to the support or the target sequence to which it specifically hybridizes may comprise a causal genetic variant. In general, causal genetic variants are genetic variants for which there is statistical, biological, and/or functional evidence of association with a disease or trait. A single causal genetic variant can be associated with more than one disease or trait. In some embodiments, a causal genetic variant can be associated with a Mendelian trait, a non-Mendelian trait, or both. Causal genetic variants can manifest as variations in a polynucleotide, such 1, 2, 3, 4, 5, 6, 7, 8, 9, 10, 20, 50, or more sequence differences (such as between a polynucleotide comprising the causal genetic variant and a polynucleotide lacking the causal genetic variant at the same relative genomic position). Non-limiting examples of types of causal genetic variants include single nucleotide polymorphisms (SNP), deletion/insertion polymorphisms (DIP), copy number variants (CNV), short tandem repeats (STR), restriction fragment length polymorphisms (RFLP), simple sequence repeats (SSR), variable number of tandem repeats (VNTR), randomly amplified polymorphic DNA (RAPD), amplified fragment length polymorphisms (AFLP), inter-retrotransposon amplified polymorphisms (IRAP), long and short interspersed elements (LINE/SINE), long tandem repeats (LTR), mobile elements, retrotransposon microsatellite amplified polymorphisms, retrotransposon-based insertion polymorphisms, sequence specific amplified polymorphism, and heritable epigenetic modification (for example, DNA methylation).

In some embodiments, a plurality of target polynucleotides may be amplified according to a method that comprises exposing a sample comprising a plurality of target polynucleotides to an apparatus of the invention. In some embodiments, the amplification process comprises bridge amplification. In some embodiments, a plurality of polynucleotides may be sequenced according to a method that comprises exposing a sample comprising a plurality of target polynucleotides to an apparatus of the invention.

In some embodiments, adapted polynucleotides may be subjected to an amplification reaction that amplifies target polynucleotides in the sample. Amplification primers may be of any suitable length, such as about, less than about, or more than about 5, 10, 15, 20, 25, 30, 35, 40, 45, 50, 55, 60, 65, 70, 75, 80, 90, 100, or more nucleotides, any portion or all of which may be complementary to the corresponding target sequence to which the primer hybridizes (e.g. about, less than about, or more than about 5, 10, 15, 20, 25, 30, 35, 40, 45, 50, or more nucleotides). “Amplification” refers to any process by which the copy number of a target sequence is increased. Methods for primer-directed amplification of target polynucleotides are known in the art, and include without limitation, methods based on the polymerase chain reaction (PCR). Conditions favorable to the amplification of target sequences by PCR are known in the art, can be optimized at a variety of steps in the process, and depend on characteristics of elements in the reaction, such as target type, target concentration, sequence length to be amplified, sequence of the target and/or one or more primers, primer length, primer concentration, polymerase used, reaction volume, ratio of one or more elements to one or more other elements, and others, some or all of which can be altered. In general, PCR involves the steps of denaturation of the target to be amplified (if double stranded), hybridization of one or more primers to the target, and extension of the primers by a DNA polymerase, with the steps repeated (or “cycled”) in order to amplify the target sequence. Steps in this process can be optimized for various outcomes, such as to enhance yield, decrease the formation of spurious products, and/or increase or decrease specificity of primer annealing. Methods of optimization may include adjustments to the type or amount of elements in the amplification reaction and/or to the conditions of a given step in the process, such as temperature at a particular step, duration of a particular step, and/or number of cycles.

Typically, annealing of a primer to its template takes place at a temperature of 25 to 90° C. A temperature in this range will also typically be used during primer extension, and may be the same as or different from the temperature used during annealing and/or denaturation. Once sufficient time has elapsed to allow annealing and also to allow a desired degree of primer extension to occur, the temperature can be increased, if desired, to allow strand separation. At this stage the temperature will typically be increased to a temperature of 60 to 100° C. High temperatures can also be used to reduce non-specific priming problems prior to annealing, and/or to control the timing of amplification initiation, e.g. in order to synchronize amplification initiation for a number of samples. Alternatively, the strands maybe separated by treatment with a solution of low salt and high pH (>12) or by using a chaotropic salt (e.g. guanidinium hydrochloride) or by an organic solvent (e.g. formamide).

Following strand separation (e.g. by heating), a washing step may be performed. The washing step may be omitted between initial rounds of annealing, primer extension and strand separation, such as if it is desired to maintain the same templates in the vicinity of immobilized primers. This allows templates to be used several times to initiate colony formation. The size of colonies produced by amplification on the solid support can be controlled, e.g. by controlling the number of cycles of annealing, primer extension and strand separation that occur. Other factors which affect the size of colonies can also be controlled. These include the number and arrangement on a surface of immobilized primers, the conformation of a support onto which the primers are immobilized, the length and stiffness of template and/or primer molecules, temperature, and the ionic strength and viscosity of a fluid in which the above-mentioned cycles can be performed.

In some embodiments, bridge amplification may be followed by sequencing a plurality of oligonucleotides attached to the solid support. In some embodiments, sequencing comprises or consists of single-end sequencing. In some embodiments, sequencing comprises or consists of paired-end sequencing. Sequencing can be carried out using any suitable sequencing technique, wherein nucleotides are added successively to a free 3′ hydroxyl group, resulting in synthesis of a polynucleotide chain in the 5′ to 3′ direction. The identity of the nucleotide added is preferably determined after each nucleotide addition. Sequencing techniques using sequencing by ligation, wherein not every contiguous base is sequenced, and techniques such as massively parallel signature sequencing (MPSS) where bases are removed from, rather than added to the strands on the surface are also within the scope of the invention, as are techniques using detection of pyrophosphate release (pyrosequencing). Such pyrosequencing based techniques are particularly applicable to sequencing arrays of beads where the beads have been amplified in an emulsion such that a single template from the library molecule is amplified on each bead. In some embodiments, sequencing comprises treating bridge amplification products to remove substantially all or remove or displace at least a portion of one of the immobilized strands in the “bridge” structure in order to generate a template that is at least partially single-stranded. The portion of the template which is single-stranded will thus be available for hybridization with a sequencing primer. The process of removing all or a portion of one immobilized strand in a bridged double-stranded nucleic acid structure may be referred to herein as “linearization.”

In some embodiments, a sequencing primer may include a sequence complementary to one or more sequences derived from an adapter oligonucleotide, an amplification primer, an oligonucleotide attached to the solid support, or a combination of these. In general, extension of a sequencing primer produces a sequencing extension product. The number of nucleotides added to the sequencing extension product that are identified in the sequencing process may depend on a number of factors, including template sequence, reaction conditions, reagents used, and other factors. In some embodiments, a sequencing primer is extended along the full length of the template primer extension product from the amplification reaction, which in some embodiments includes extension beyond a last identified nucleotide. In some embodiments, the sequencing extension product is subjected to denaturing conditions in order to remove the sequencing extension product from the attached template strand to which it is hybridized, in order to make the template partially or completely single-stranded and available for hybridization with a second sequencing primer.

In some embodiments, one or more, or all, of the steps of the method described herein may be automated, such as by use of one or more automated devices. In general, automated devices are devices that are able to operate without human direction—an automated system can perform a function during a period of time after a human has finished taking any action to promote the function, e.g. by entering instructions into a computer, after which the automated device performs one or more steps without further human operation. Software and programs, including code that implements embodiments of the present invention, may be stored on some type of data storage media, such as a CD-ROM, DVD-ROM, tape, flash drive, or diskette, or other appropriate computer readable medium. Various embodiments of the present invention can also be implemented exclusively in hardware, or in a combination of software and hardware. For example, in one embodiment, rather than a conventional personal computer, a Programmable Logic Controller (PLC) is used. As known to those skilled in the art, PLCs are frequently used in a variety of process control applications where the expense of a general purpose computer is unnecessary. PLCs may be configured in a known manner to execute one or a variety of control programs, and are capable of receiving inputs from a user or another device and/or providing outputs to a user or another device, in a manner similar to that of a personal computer. Accordingly, although embodiments of the present invention are described in terms of a general purpose computer, it should be appreciated that the use of a general purpose computer is exemplary only, as other configurations may be used.

In some embodiments, automation may include the use of one or more liquid handlers and associated software. Several commercially available liquid handling systems can be utilized to run the automation of these processes (see for example liquid handlers from Perkin-Elmer, Beckman Coulter, Caliper Life Sciences, Tecan, Eppendorf, Apricot Design, Velocity 11 as examples). In some embodiments, automated steps include one or more of fragmentation, end-repair, A-tailing (addition of adenine overhang), adapter joining, PCR amplification, sample quantification (e.g. amount and/or purity of DNA), and sequencing. In some embodiments, hybridization of amplified polynucleotides to oligonucleotides attached to a solid surface, extension along the amplified polynucleotides as templates, and/or bridge amplification is automated (e.g. by use of an Illumina cBot). In some embodiments, sequencing may automated. A variety of automated sequencing machines are commercially available, and include sequencers manufactured by Life Technologies (SOLiD platform, and pH-based detection), Roche (454 platform), Illumina (e.g. flow cell based systems, such as Genome Analyzer, HiSeq, or MiSeq systems). Transfer between 2, 3, 4, 5, or more automated devices (e.g. between one or more of a liquid handler, a bridge amplification device, and a sequencing device) may be manual or automated.

In some embodiments, exponentially amplified target polynucleotides may be sequenced. Sequencing may be performed according to any method of sequencing known in the art, including sequencing processes described herein, such as with reference to other aspects of the invention. Sequence analysis using template dependent synthesis can include a number of different processes. For example, in the ubiquitously practiced four-color Sanger sequencing methods, a population of template molecules is used to create a population of complementary fragment sequences. Primer extension is carried out in the presence of the four naturally occurring nucleotides, and with a sub-population of dye labeled terminator nucleotides, e.g., dideoxyribonucleotides, where each type of terminator (ddATP, ddGTP, ddTTP, ddCTP) includes a different detectable label. As a result, a nested set of fragments is created where the fragments terminate at each nucleotide in the sequence beyond the primer, and are labeled in a manner that permits identification of the terminating nucleotide. The nested fragment population is then subjected to size based separation, e.g., using capillary electrophoresis, and the labels associated with each different sized fragment is identified to identify the terminating nucleotide. As a result, the sequence of labels moving past a detector in the separation system provides a direct readout of the sequence information of the synthesized fragments, and by complementarity, the underlying template. Other examples of template dependent sequencing methods include sequence by synthesis processes, where individual nucleotides are identified iteratively, as they are added to the growing primer extension product (e.g., pyrosequencing).

FIG. 6 is a block diagram of an example system 600 for optimizing performance of a DNA-based noninvasive prenatal screen. As illustrated in this figure, example system 600 may include one or more modules 622 for performing one or more tasks. As will be described in greater detail below, modules 622 may include a synthetic sequencing module 624 that generates synthetic sequencing datasets. Modules 622 may also include an abnormality caller module 626 that calculates potential impacts of CNVs on fetal chromosomal abnormality calls during DNA-based noninvasive prenatal screening. Additionally, modules 622 may include an analysis module 628 that determines threshold feature values utilized in the DNA-based noninvasive prenatal screening to identify likely false fetal chromosomal abnormality calls. Modules 622 may also include a correction module 630 that adjusts sequencing read quantities and/or z-scores to compensate for CNVs.

In certain embodiments, one or more of modules 622 in FIG. 6 may represent one or more software applications or programs that, when executed by a computing device, may cause the computing device to perform one or more tasks. For example, and as will be described in greater detail below, one or more of modules 622 may represent modules stored and configured to run on one or more computing devices. One or more of modules 622 in FIG. 6 may also represent all or portions of one or more special-purpose computers configured to perform one or more tasks.

As illustrated in FIG. 6, example system 600 may also include one or more memory devices, such as memory 620. Memory 620 generally represents any type or form of volatile or non-volatile storage device or medium capable of storing data and/or computer-readable instructions. In one example, memory 620 may store, load, and/or maintain one or more of modules 622. Examples of memory 620 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 6, example system 600 may also include one or more physical processors, such as physical processor 640. Physical processor 640 generally represents any type or form of hardware-implemented processing unit capable of interpreting and/or executing computer-readable instructions. In one example, physical processor 640 may access and/or modify one or more of modules 622 stored in memory 620. Additionally or alternatively, physical processor 640 may execute one or more of modules 622. Examples of physical processor 640 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 7 is a flow diagram of an exemplary method 700 for optimizing performance of a DNA-based noninvasive prenatal screen. Some of the steps shown in FIG. 7 may be performed by any suitable computer-executable code and/or computing system, including system 600 in FIG. 6. In one example, some of the steps shown in FIG. 7 may represent an algorithm whose structure includes and/or is represented by multiple sub-steps, examples of which will be provided in greater detail below.

As illustrated in FIG. 7, at step 702, one or more of the systems described herein may generate a plurality of synthetic sequencing datasets, each of the plurality of synthetic sequencing datasets representing genetic sequencing data from a sample including maternal and fetal cell-free DNA (cfDNA), by, for each of the plurality of synthetic sequencing datasets (i) generating at least one of a plurality of synthetic copy number variants including a synthetic number of copies of at least a portion of a region of interest represented by a synthetic number of sequencing reads from one or more segments within the region of interest, (ii) and modifying a real sequencing dataset, which includes genetic sequencing data from a real test sample including maternal and fetal cfDNA, by replacing a number of real sequencing reads from the one or more segments within the region of interest in the real test sample with the synthetic number of sequencing reads. For example, synthetic sequencing module 624 shown in FIG. 6 may generate a plurality of synthetic sequencing datasets, each of the plurality of synthetic sequencing datasets representing genetic sequencing data from a sample including maternal and fetal cfDNA in a variety of ways, as described herein.

In some embodiments, synthetic sequencing module 624 may generate each of the plurality of synthetic sequencing datasets by generating at least one of a plurality of synthetic copy number variants including a synthetic number of copies of at least a portion of a region of interest represented by a synthetic number of sequencing reads from one or more segments within the region of interest. Each of the plurality of synthetic copy number variants may include a deletion or a duplication. Additionally, synthetic sequencing module 624 may generate each of the plurality of synthetic sequencing datasets by then modifying a real sequencing dataset, which includes genetic sequencing data from a real test sample including maternal and fetal cfDNA, by replacing a number of real sequencing reads from the one or more segments within the region of interest in the real test sample with the synthetic number of sequencing reads. In at least one embodiment, the at least one of the plurality of synthetic copy number variants may include a synthetic maternal copy number variant and a corresponding synthetic fetal copy number variant. For example, cfDNA samples analyzed in non-invasive prenatal screening that are determined to include a maternal CNV are commonly treated as including the CNV in the fetal DNA as well the maternal DNA, with the CNV being assumed to be passed from the mother to the child. Accordingly, attempts to distinguish a maternal CNV from a fetal CNV may not be made. In some examples, the at least one of the plurality of synthetic copy number variants may generated to represent a synthetic maternal copy number variant without a corresponding synthetic fetal copy number variant. For example, to determine the impact of maternal CNV on a fetal chromosomal abnormality call in a cfDNA sample that does not include a corresponding fetal CNV, a synthetic sequencing dataset may be generated to represent a synthetic sample that includes a synthetic maternal CNV with no corresponding fetal CNV.

Real samples having a copy number variant, such as a duplication or deletion, for a particular region of interest (such as a gene or plurality of genes) may be relatively rare. Many putative CNVs may be identified from a retrospective analysis of whole-genome sequencing data from previously sequenced DNA samples from individuals. The vast majority of putative CNVs in such a retrospective analysis may represent relatively shorter CNVs of several thousand base pairs to several hundred thousand base pairs in length and spanning only a small portion of the respective chromosomes harboring the CNVs. However, many potential CNVs and/or CNV lengths may not be represented in such sequencing data. Particularly, relatively larger CNVs, which are much more likely to result in a false aneuploidy call in cfDNA-based prenatal screening, are much less common in the general population (see, e.g., FIGS. 2A-D). Large CNVs spanning millions of base pairs are very uncommon, particularly in human chromosome 21 (having a length of approximately 48 Mb), which is much shorter than chromosome 13 (having a length of approximately 115 Mb) and chromosome 18 (having a length of approximately 78 Mb). CNVs spanning more than 10 Mb are empirically rare in the healthy pregnant population.

In order to supplement the retrospective data for purposes of optimizing the performance of the DNA-based noninvasive prenatal screen, synthetic CNVs in human chromosomes 1, 13, 18, 21, and/or X and/or any other human chromosomes may be generated. In some embodiments, each of the plurality of synthetic sequencing datasets may include a synthetic number of sequencing reads for one or more segments of a reference chromosome. Each of the plurality of synthetic sequencing datasets may represent a chromosome or portion of a chromosome having at least one of a plurality of synthetic maternal copy number variants (e.g., a deletions and/or a duplications) at locations corresponding to the one or more segments of the reference chromosome.

The one or more segments of the reference chromosome may be of any suitable length, without limitation. For example, the one or more segments of the reference chromosome may each be about 1 base to about 250 million bases in length (such as about 1 base to about 50 bases in length, about 50 bases to about 100 bases in length, about 100 bases to about 250 bases in length, about 250 bases to about 500 bases in length, about 500 base to about 1000 bases in length, about 1000 bases to about 2000 bases in length, about 2000 bases to about 4000 bases in length, about 4000 bases to about 8000 bases in length, about 8000 bases to about 16,000 bases in length, about 16,000 bases to about 32,000 bases in length, about 32,000 bases to about 64,000 bases in length, about 64,000 bases to about 125,000 bases in length, about 125,000 bases to about 250,000 bases in length, about 250,000 bases to about 500,000 bases in length, about 500,000 bases to about 1 million bases in length, about 1 million bases to about 2 million bases in length, about 2 million bases to about 4 million bases in length, about 4 million bases to about 8 million bases in length, about 8 million bases to about 16 million bases in length, about 16 million bases to about 32 million bases in length, about 32 million bases to about 64 million bases in length, about 64 million bases to about 125 million bases in length, or about 125 million bases to about 250 million bases in length). In some embodiments, the one or more segments of the reference chromosome may each be about 1 base or more (such as about 50 bases or more, about 100 bases or more, about 250 bases or more, about 500 bases or more, about 1000 bases or more, about 2000 bases or more, about 4000 bases or more, about 8000 bases or more, about 16,000 bases or more, about 32,000 bases or more, about 64,000 bases or more, about 125,000 bases or more, about 250,000 bases or more, about 500,000 bases or more, about 1 million bases or more, about 2 million bases or more, about 4 million bases or more, about 8 million bases or more, about 16 million bases or more, about 32 million bases or more, about 64 million bases or more, or about 125 million bases or more. In some embodiments, the one or more segments of the reference chromosome may include one or more genes (such as 2, 3, 4, 5, 6, 7, 8, 9, 10, 11, 12, 13, 14, 15, 16, 17, 18, 19, 20, 25, 30, 40, 50, 75, 100, 150, 200, 250 or more genes). In some embodiments, the one or more segments of the reference chromosome may include one or more exons (such as 2, 3, 4, 5, 6, 7, 8, 9, 10, 11, 12, 13, 14, 15, 16, 17, 18, 19, 20, 25, 30, 40, 50, 75, 100, 150, 200, 250 or more exons).

The one or more segments of the reference chromosome may or may not be continuous, contiguous, or partially overlapping. In some embodiments, the one or more segments of the reference chromosome may include 1 or more segments (such as 2, 3, 4, 5, 6, 7, 8, 9, 10, 11, 12, 13, 14, 15, 16, 17, 18, 19, 20, 25, 30, 40, 50, 75, 100, 150, 200, 250 or more segments). The synthetic number of sequencing reads (or a portion of the sequencing reads) may each correspond to one of the one or more segments of the reference chromosome (i.e., the sequencing reads can be aligned to segments, for example using a reference sequence). It is understood that a portion of the synthetic number of sequencing reads may not accurately map to a particular segment (for example, a sequencing read may map to more than one segment or may map to no segment); such un-mappable or un-alignable sequencing reads are optionally ignored or discarded.

In some embodiments, at least a portion of one or more real samples may be sequenced to generate real sequencing reads. The real sequencing reads may be generated from one or more real samples (e.g., one or more sequencing libraries from the one or more real samples) using any known sequencing method, such as massively parallel sequencing (for example using an Illumina HiSeq 2500 system). In some embodiments, at least one region of interest, such as one or more specified chromosomes (e.g., chromosome 1, 13, 18, 21, X, and/or Y), and/or one or more portions thereof (e.g., regions of interest), may be enriched, which can increase the proportion of sequencing reads that correspond to the enriched regions. For example, one or more regions of interest may be enriched by PCR (for example, by including one or more primers that hybridize to portions of segments within the regions of interest with genomic DNA from a real sample, and amplifying the segments within the regions of interest). In some embodiments, one or more regions of interest may be enriched by combining capture probes (such as biotinylated DNA, RNA, synthetic oligonucleotides) that hybridize to segments within the regions of interest with genomic DNA (which is preferably sheared). The capture probes may then be used to isolate DNA fragments that include segments from the regions of interest, and those DNA fragments can be sequenced to generate sequencing reads.

In some embodiments, real sequencing reads may be normalized. For example, in some embodiments, the real sequencing reads may be normalized for GC content and/or mappability. For example, some segments within one or more regions of interest may have a higher GC content than other segments within the region of interest. The higher GC content may increase or decrease the assay efficiency within that segment, inflating or deflating the relative number of sequencing reads for reasons other than copy number. Methods to normalize GC content may include, for example, methods as described in Fan & Quake, PLoS ONE, vol. 5, e10439 (2010). Similarly, certain segments within the one or more regions of interest may be more easily mappable (or alignable to a reference region of interest), and a number of sequencing reads may be excluded, thereby deflating the relative number of sequencing reads for reasons other than copy number. Mappability at a given position in the genome may be predetermined for a given read length, k, by segmenting every position within a region of interest into k-mers and aligning the sequences back to the region of interest. K-mers that align to a unique position in the interrogated region are labeled “mappable,” and k-mers that do not align to a unique position in the region of interest are labeled “not mappable.” A given segment may be normalized for mappability by scaling the number of reads in the segment by the inverse of the fraction of the mappable k-mers in the segment. For example, if 50% of k-mers within a bin are mappable, the number of observed reads from within that segment may be scaled by a factor of 2.

In some embodiments, the synthetic number of sequencing reads from each of the one or more segments may be generated by increasing or decreasing a number of real sequencing reads from one or more segments within a region (e.g., the region of interest) in the real test sample and/or within a region (e.g., the region of interest) in a reference sequence that is, for example, derived based on a combination of a plurality of test samples. For example, if a first number of real sequencing reads corresponds to a first segment in a region of interest, and a second number of real sequencing reads corresponds to a second segment in the region of interest, and the real sample has two copies of the region of interest, a synthetic copy number variant representing a duplication having three copies of the region of interest may be generated by generating a first synthetic number of sequencing reads corresponding to the first segment by increasing the first number of real sequencing reads to reflect three copies of the first segment, and generating a second synthetic number of sequencing reads corresponding to the second segment by increasing the second number of real sequencing reads to reflect three copies of the second segment. Since the synthetic number of sequencing reads corresponding to the first segment and the second segment are increased to reflect three copies, the synthetic copy number variant has three copies of the region of interest having the first segment and the second segment. In some embodiments, the synthetic number of sequencing reads may be normalized. For example, in some embodiments, the synthetic number of sequencing reads may be normalized for GC content and/or mappability.

In some embodiments, the synthetic number of sequencing reads may be generated by multiplying the number of real sequencing reads by a factor (such as 1.5 to increase the copy number from two to three, or 0.5 to decrease the copy number from two to one) and/or by applying binomial downsampling to the number of real sequencing reads (e.g., to simulate deletions). In some embodiments, the expected ratio of bin copy numbers in maternal duplications vs. non-mCNV regions may be 3/2=1.50, but this factor may be observed to be slightly lower at 2.88/2=1.44. This approach assumes that simulated mCNVs were inherited by the fetus. mCNVs not inherited by the fetus may have a marginally decreased signal in proportion to the fetal fraction, and this may reduce their potentially compromising effect on specificity but also make them slightly more difficult to detect. In some embodiments, the synthetic number of sequencing reads are generated by adding (or subtracting) a number of sequencing reads (such as 50% of the average number of real sequencing reads corresponding to all segments within the region of interest) to the number of real sequencing reads. In some embodiments, the number of sequencing reads may be normalized such that a single copy of a region of interest is represented by a normalized number of sequencing reads (e.g., 0.5), and two copies of a region of interest are represented by a normalized number of sequencing reads (e.g., 1). Thus, in some embodiments, a number of normalized sequencing reads (such as 0.5) may be added to the normalized number of sequencing reads to increase the number of copies in the synthetic copy number variant, and a number of normalized sequencing reads (such as 0.5) may be subtracted from the normalized number of sequencing reads to decrease the number of copies in the synthetic copy number variant.

In some embodiments, the number of real sequencing reads may be increased or decreased to generate the synthetic number of sequencing reads to represent a synthetic copy number variant with an integer number of copies of the region of interest (such as 1, 2, 3, 4, 5, or more copies of the region of interest). In at least one embodiment, the number of real sequencing reads from each of the one or more segments within the region of interest in the real test sample may be normalized by dividing the number of real sequencing reads from each segment from the real test sample by an average number of real sequencing reads from a corresponding segment from one or more real reference samples or by an average number of real sequencing reads from one or more segments within the region of interest in the real test sample. According to some embodiments, the number of real sequencing reads from each of the one or more segments within the region of interest in the real test sample may be normalized by fitting a probability distribution based on random subsampling. For example, rather than multiplying by set value to normalize the number of real sequencing reads, a probability distribution based on random subsampling may be used (e.g. a binomial distribution with the number of trials equaling the depth and the probability of success equaling 0.5). Any suitable systems and methods for generating synthetic sequencing reads may be utilized, without limitation, including, for example, systems and methods disclosed in U.S. Patent Application No. 62/418,622.

FIG. 8 shows a plot of various exemplary real and synthetic copy number variants corresponding to segments of a chromosome. The copy number variants shown in FIG. 8 include a real duplication (copy number of 3) and a real deletion (copy number of 1) observed from sequencing and analysis of real test samples. Additionally, the illustrated copy number variants include a synthetic duplication (copy number of 3) and a synthetic deletion (copy number of 1) generated in accordance with systems and methods described herein. The plot in FIG. 8 includes sequencing read counts for a plurality of bins corresponding to the respective chromosome regions, with the left Y-axis of the plot showing loge fold enrichment and the right Y-axis showing the corresponding copy number (log-scale axis).

Returning to FIG. 7, at step 704, one or more of the systems described herein may calculate a potential impact of each of the plurality of synthetic copy number variants on a fetal chromosomal abnormality call during DNA-based noninvasive prenatal screening based on the plurality of synthetic sequencing datasets. For example, abnormality caller module 626 in FIG. 6 may calculate a potential impact of each of the plurality of synthetic copy number variants on a fetal chromosomal abnormality call during DNA-based noninvasive prenatal screening based on the plurality of synthetic sequencing datasets.

Abnormality caller module 626 may calculate the potential impact of each of the plurality of synthetic copy number variants on the corresponding fetal chromosomal abnormality call in a variety of ways. For example, abnormality caller module 626 may determine whether a synthetic CNV has a large enough effect on a calculated z-score of a fetal chromosomal abnormality call to change its interpretation (i.e., whether the z-score is inside or outside of a “normal” z-score range). In some examples, abnormality caller module 626 may determine whether or not each synthetic sequencing dataset is likely to result in a false fetal chromosomal abnormality call during noninvasive prenatal screening, which utilizes cfDNA containing both maternal DNA and fetal DNA. By way of example, abnormality caller module 626 may determine whether sequences contributed by one or more duplications represented in a synthetic sequencing dataset would contribute enough additional reads utilized during noninvasive prenatal screening to push the total reads for a corresponding sample above a positive call threshold, resulting in a false-positive aneuploidy call. (See, e.g., FIG. 1C). In at least one embodiment, abnormality caller module 626 may determine whether sequences deleted by one or more deletions represented in a synthetic sequencing dataset would eliminate enough reads utilized during noninvasive prenatal screening to keep the total reads for a corresponding sample below a positive call threshold, resulting in a false-negative aneuploidy call. (See, e.g., FIG. 1D).

In some embodiments, calculating the synthetic copy number variants on a fetal chromosomal abnormality call may include determining a quantity of target sequencing reads in each of the plurality of synthetic sequencing datasets, the target sequencing reads corresponding to identified target sequences. For example, for each of the synthetic sequencing datasets, abnormality caller module 626 may determine a quantity of target sequencing reads in each of the plurality of synthetic sequencing datasets. In some embodiments, the target sequencing reads may be reads of a specified length or lengths (e.g., k-mers) that are mappable to a reference genome. In some embodiments, the target sequencing reads may be sequencing reads that are each mappable to a reference sequence. In at least one embodiment, the target sequencing reads may be unique reads that each match only a single point (i.e., unique location) in a reference genome. In at least one embodiment, mappable target sequencing reads may be utilized by abnormality caller module 626, and un-mappable or un-alignable sequencing reads may be ignored or discarded.

In various embodiments, calculating the potential impact of each of the plurality of synthetic copy number variants on the fetal chromosomal abnormality call may further include calculating a value indicative of the potential effect of the copy number variant represented in each of the synthetic copy number variants. In some embodiments, a value of statistical significance (e.g., z-score or standard score, p-value, probability, etc.) may be calculated to determine the potential impact.

In at least one embodiment, abnormality caller module 626 may calculate a statistical z-score for each of the plurality of synthetic sequencing datasets. In cfDNA-based noninvasive prenatal screening, a value of likelihood that the fetal cfDNA in the test maternal sample is abnormal (e.g., aneuploid or includes a microdeletion or a microduplication) may be determined using a z-score, which is a statistical value indicating how many standard deviations a quantity of target sequences for a specified chromosome or portion of a chromosome in a cfDNA sample from a pregnant individual is from a mean or median reference quantity for the specified chromosome or portion of the chromosome.

For purposes of calculating the potential impact of each of the plurality of synthetic CNVs represented in the plurality of synthetic sequencing datasets on the aneuploidy call, a statistical z-score may be calculated for each of the plurality of synthetic sequencing datasets. In some embodiments, calculating the statistical z-score for each of the plurality of CNVs may further include calculating a quantity of target sequencing reads in a region of interest (e.g., chromosome or selected portion of chromosome) attributable to at least one CNV, such as a synthetic CNV. For example, a number of target sequencing reads obtained for a specified chromosome (e.g., 1, 13, 18, 21, X, or any other specified chromosome), or chromosome of interest, or selected portion of the chromosome, corresponding to the synthetic sequencing datasets may be determined in comparison to a number of target sequencing reads obtained from the specified chromosome or selected portion of the chromosome. For example, for a region of interest that includes a CNV, an average number of read counts may be determined for the region of interest represented by the synthetic sequencing dataset.

The z-score may be determined based on an average number of read counts in the region of interest (i.e., chromosome or portion of chromosome) of the synthetic sequencing dataset with respect to a background that includes a distribution of the average number of read counts in the region of interest of a plurality of other samples (i.e., a sample population), which includes, for example, a plurality of samples that do not include the CNV. The z-score may be determined by dividing a difference between the average number of read counts of in the region of interest and the average number of read counts of the sample population in the region of interest by a variation (e.g., average absolute deviation) in the average number of read counts for the sample population (or by a variation in the average number of read counts for all samples, including the synthetic sequencing dataset and/or additional synthetic chromosomes). In some embodiments, the background may be generated, at least in part, based on reference samples that are tailored to the synthetic sequencing dataset. For example, reference samples sharing one or more common characteristics with the synthetic sequencing dataset may be selected for the background. In one example, reference samples sharing a similar cfDNA fetal fraction may be utilized to generate the background. In some examples, the background used for a synthetic sequencing dataset may additionally or alternatively be generated, at least in part, based on reference samples that were sequenced and analyzed in one or more batches (e.g., a batch of samples sequenced on the same next-generation sequencing (NGS) sample plate), including real test samples that were sequenced in the same batch as the real test sample used to generate the synthetic sequencing dataset.

In some embodiments, target reads for the remainder of the genome, aside from the specified chromosome corresponding to the synthetic sequencing datasets, may correspond to reads obtained from chromosomes including few or no CNVs. In at least one embodiment, each of the target reads for the remainder of the genome may correspond to sequencing reads obtained from a reference genome and/or to sequencing reads obtained from real samples having few or no CNVs. In some embodiments, one or more of the target reads for the remainder of the genome may correspond to sequencing reads obtained from chromosomes including one or more CNVs (e.g., reads from real samples or reference samples, and/or reads from synthesized chromosome sequencing reads). In some embodiments, a z-score may be determined for a region of interest for a chromosome and/or portion of a chromosome that does not include a CNV, such as a simulated CNV.

In at least one embodiment, calculating the potential impact of each of the plurality of synthetic CNVs on the fetal chromosomal abnormality call may further include calculating a statistical z-score change attributable to the at least one CNV represented by the respective synthetic sequencing dataset. For example, calculating the statistical z-score change attributable to at least one CNV represented by a synthetic sequencing dataset may include calculating a statistical z-score for the region of interest in the synthetic sequencing dataset with respect to a z-score from a corresponding background dataset. A difference (or change) in z-score between the synthetic sequencing dataset and the background dataset may be attributed and correlated to the at least one synthetic CNV. In some embodiments, calculated statistical z-score changes may each be correlated to a CNV size of the at least one of the plurality of synthetic CNVs.

In some embodiments, calculating the potential impact of each of the plurality of synthetic CNVs on the fetal chromosomal abnormality call may further include determining whether or not a statistically significant value, such as a statistical z-score, calculated for each of the plurality of synthetic CNVs is outside of a threshold range. For example, abnormality caller module 626 may use a specified range of z-scores to determine whether each of the plurality of synthetic CNVs is likely to affect a fetal chromosomal abnormality call for the specified chromosome during DNA-based noninvasive prenatal screening. In some embodiments, a range of z-scores determined to correlate to synthetic CNVs that are likely to not affect a fetal chromosomal abnormality call may range from about −6 to about 6, about −5 to about 5, about −4 to about 4, about −3.5 to about 3.5, about −3 to about 3, about −2.5 to about 2.5, or about −2 to about 2. A calculated z-score outside of at least one of these ranges may be determined to correlate to a synthetic CNV that is likely to affect a fetal chromosomal abnormality call, with a value outside a range corresponding to a potential false fetal chromosomal abnormality determination (i.e., false-positive, false-negative). In some embodiments, a z-score range may be adjusted based on other samples from a batch used to generate a synthetic sequencing dataset and/or based on characteristics of the synthetic sequencing dataset (e.g., fetal fraction).

In some embodiments, the method may further include correlating each of the calculated statistical z-scores, or z-score changes, to a size of the at least one synthetic CNV represented in the corresponding synthetic sequencing dataset. For example, analysis module 628 shown in FIG. 6 may correlate each of the calculated statistical z-scores to a CNV size of the at least one CNV represented by the respective synthetic sequencing dataset. In at least one embodiment, the calculated statistical z-scores may each be correlated with a percentage of a corresponding chromosome covered by at least one CNV (or a combined percentage of the chromosome covered by multiple CNVs), examples of which are shown and discussed below in connection with FIGS. 8 and 9. In one embodiment, the calculated statistical z-scores may each be correlated with a base pair length of at least one CNV (or a combined length of multiple CNVs).

In some embodiments, the method may further include correlating each of the calculated statistical z-scores, or z-score changes, to a type of the at least one CNV represented in the corresponding synthetic sequencing dataset. For example analysis module 628 shown in FIG. 6 may correlate each of the calculated statistical z-scores to a CNV type of the at least one CNV represented in the respective synthetic sequencing dataset, with the CNVs being grouped based on whether they are duplications or a deletions.

According to at least one embodiment, calculating the statistical z-score for the region of interest in the corresponding synthetic sequencing dataset may include calculating an average read count in the region of interest in the corresponding synthetic sequencing dataset. For example, calculating the statistical z-score for each of the plurality of synthetic sequencing datasets may include determining a number of target sequencing reads in each of a plurality of bins (see, e.g., FIGS. 3-5). The statistical z-scores may, for example, be calculated based on the average number of target sequencing reads per bin for the plurality of bins based on background averages per bin for the corresponding bins.

In some embodiments, calculating the statistical z-score for each of the plurality of synthetic sequencing datasets may include calculating a statistical z-score for another region of interest in the corresponding synthetic sequencing dataset. Calculating the statistical z-score for the other region of interest in the corresponding synthetic sequencing dataset may, for example, include calculating an average read count in the other region of interest in the corresponding synthetic sequencing dataset. In at least one embodiment, one or more of the plurality of synthetic sequencing datasets may further include sequencing reads from one or more additional segments corresponding to real copy number variants in the respective real test samples.

According to some embodiments, one or more of the systems described herein may determine, based on the calculated potential impacts of the plurality of synthetic CNVs on the fetal chromosomal abnormality calls, at least one threshold feature value utilized in the DNA-based noninvasive prenatal screening to identify likely false fetal chromosomal abnormality calls. For example, analysis module 628 shown in FIG. 6 may determine, based on the calculated potential impacts of the plurality of synthetic CNVs on the fetal chromosomal abnormality calls, at least one threshold feature value utilized in the DNA-based noninvasive prenatal screening to identify likely false fetal chromosomal abnormality calls.

In some embodiments, analysis module 628 may determine the at least one threshold feature value based on correlations between z-scores and one or more characteristic of corresponding CNVs represented in the respective synthetic sequencing datasets. In at least one embodiment, the at least one threshold feature value may include a threshold percentage of corresponding chromosome covered by at least one CNV and/or a threshold base pair length of at least one CNV in the specified chromosome. For example, numerous synthetic sequencing datasets for one or more other chromosome may be used to determine correlations between z-scores and percentages of chromosomes covered by corresponding CNVs and/or base pair lengths of CNVs. These correlations may be utilized to determine one or more threshold values and/or ranges of values for CNVs that may be utilized in noninvasive prenatal screenings to identify likely false fetal chromosomal abnormality calls one or more chromosomes. For example, a threshold CNV value may be determined based on identification of an increased potential for a false fetal chromosomal abnormality call above the threshold CNV value. In some embodiments, such correlations may be utilized to determine likelihoods of false fetal chromosomal abnormality calls for one or more chromosomes based on a percentage of a chromosome covered by one or more CNVs and/or a base pair length of one or more CNVs.

In some embodiments, a threshold percentage of a chromosome covered by at least one maternal CNV may be utilized as a threshold CNV value in DNA-based noninvasive prenatal screening of more than one chromosome. For example, while human chromosome 21 has far fewer base pairs (approximately 48 Mb) than human chromosome 13 (having approximately 115 Mb), the same or substantially the same threshold percentage of a chromosome covered by at least one maternal CNV may utilized in noninvasive prenatal screening for fetal chromosomal abnormality in both chromosome 21 and chromosome 13. While a much longer CNV may be necessary to potentially trigger a false fetal chromosomal abnormality call for chromosome 13 than for chromosome 21, the threshold percentage of the chromosome occupied by the CNVs, above which a false fetal chromosomal abnormality call may be triggered, may be the same or substantially the same for both chromosome 13 and chromosome 21.

In some embodiments, the at least one threshold feature value may be utilized in response to certain factors during noninvasive prenatal screening. For example, the at least one threshold feature value may be utilized in response to at least one positive fetal chromosomal abnormality call (e.g., an initial aneuploidy call) by an abnormality caller. In at least one embodiment, when an abnormality caller returns a positive call indicating a fetal chromosomal abnormality (e.g., trisomy, monosomy, microdeletion, microduplication, etc.) in a chromosome during noninvasive prenatal screening, the at least one threshold feature value may be utilized to further review and/or confirm the positive call. For example, quality-control metrics and/or manual review, such as computer-assisted manual review, of the sequenced cfDNA sample may be utilized to identify a maternal CNV, such as a duplication, in the chromosome for which the fetal aneuploidy was called. If a maternal CNV, or likely maternal CNV, is identified in the chromosome, the size of the CNV may be calculated. The threshold feature value may be utilized to determine whether the CNV likely resulted in a false-positive fetal chromosomal abnormality call. For example, if the CNV value (e.g., CNV size) is above the threshold feature value, the positive fetal chromosomal abnormality call may be determined to likely be a false-positive call. However, if the CNV value is below the threshold feature value, the positive fetal chromosomal abnormality call may be determined to likely be a likely true-positive call. Such a determination may result in more accurate false-positive fetal chromosomal abnormality determinations during noninvasive prenatal screening, while also preventing expectant mothers from unnecessarily undertaking invasive follow-up testing to confirm the existence of a fetal chromosomal abnormality in cases where the noninvasive prenatal screening produces a false-positive call due to a maternal CNV. In some embodiments, the impact of a false fetal chromosomal abnormality call (e.g., false positive or false-negative) due to a maternal CNV may be mitigated by identifying the location and/or type of maternal CNV and performing further steps to undo the effect of the maternal CNV on fetal chromosomal abnormality detection.

In some embodiments, the at least one threshold feature value may be utilized in response to at least one negative fetal chromosomal abnormality call by an abnormality caller. In at least one embodiment, when an abnormality caller returns a negative fetal chromosomal abnormality call for a chromosome during noninvasive prenatal screening, the at least one threshold feature value may be utilized to further review and/or confirm the negative call. For example, quality-control metrics and/or manual review, such as computer-assisted manual review, of the sequenced cfDNA sample may be utilized to identify a maternal CNV, such as a deletion, in the chromosome. If a maternal CNV, or likely maternal CNV, is identified in the chromosome, the size of the CNV may be calculated. The threshold feature value may be utilized to determine whether the CNV likely resulted in a false-negative fetal chromosomal abnormality call. For example, if the CNV value (e.g., CNV size) is above the threshold feature value, the negative fetal chromosomal abnormality call may be determined to likely be a false-negative call. However, if the CNV value is below the threshold feature value, the negative fetal chromosomal abnormality call may be determined to likely be a likely true-negative call.

In some embodiments, the method may include determining, based on the calculated potential impacts of the plurality of synthetic copy number variants on the fetal chromosomal abnormality calls, robustness of a fetal abnormality caller. For example, analysis module 628 may determine, based on the calculated potential impacts of the plurality of synthetic CNVs on the fetal chromosomal abnormality calls, robustness of one or more fetal abnormality callers. In some examples, the robustness may be determined based on the calculated potential impacts of the plurality of synthetic CNVs and potential or observed impacts of a plurality of real CNVs. In at least one embodiment, the method may further include modifying the fetal abnormality caller based on the determined robustness of the fetal abnormality caller. According to some embodiments, determining the robustness of the fetal abnormality caller may include determining a specificity of the fetal abnormality caller over a range of synthetic copy number variant sizes. For example, analysis module 628 may determine a specificity of the fetal abnormality caller over a range of synthetic CNVs, such as a range of percentages of a corresponding chromosome covered by a CNV.

In at least one embodiment, the determined correlations between z-scores and one or more characteristics of corresponding CNVs represented in the respective synthetic sequencing datasets may be utilized to determine and/or improve the robustness of a fetal abnormality caller utilized in DNA-based noninvasive prenatal screening. For example, such correlations may demonstrate that a particular abnormality caller (e.g., an outlier-robust algorithm) is likely to correctly identify euploidies and fetal chromosomal abnormalities (e.g., aneuploidies, microdeletions, and/or microduplications) with high specificity in fetal DNA when the maternal DNA in the cfDNA sample includes one or more CNVs in a chromosome of interest. The correlations may be used to modify one or more fetal abnormality callers and/or to select a fetal abnormality caller that is best suited to identify fetal chromosomal abnormalities in cfDNA samples having a range of maternal CNV sizes. Moreover, these correlations may demonstrate that the abnormality caller is likely to correctly identify euploidies and fetal chromosomal abnormalities in fetal DNA up to a determined maternal CNV size (e.g., a threshold CNV size) in the chromosome of interest. In some embodiments, the threshold feature value may differ depending on the type of maternal CNV (e.g., duplication and/or deletion) in the chromosome of interest and/or based on the type of call (e.g., positive or negative fetal chromosomal abnormality) indicated by an abnormality caller during noninvasive prenatal screening. In at least one embodiment, the threshold feature may additionally or alternatively differ based on the amount of fetal fraction in a given cfDNA sample (e.g., a sample including a high fetal fraction may be impacted less by CNVs due to a better sample signal obtained from the fetal fraction).

According to some embodiments, calculating the potential impact of each of the plurality of synthetic copy number variants on the fetal chromosomal abnormality call may further include calculating a potential impact of each of the plurality of synthetic copy number variants on a fetal chromosomal abnormality call for a specified chromosome that includes the region of interest during DNA-based noninvasive prenatal screening. For example, abnormality caller module 626 may utilize a synthetic CNV in chromosome 21 to calculate the potential impact of the synthetic CNV on a fetal chromosomal abnormality call for chromosome 21. Additionally or alternatively, calculating the potential impact of each of the plurality of synthetic copy number variants on the fetal chromosomal abnormality call may further include calculating a potential impact of each of the plurality of synthetic copy number variants on a fetal chromosomal abnormality call for a chromosome that does not include the region of interest during DNA-based noninvasive prenatal screening. For example, abnormality caller module 626 may utilize a synthetic CNV in a chromosome other than chromosome 21 to calculate the potential impact of the synthetic CNV on a fetal chromosomal abnormality call for chromosome 21.

In some embodiments, the method may further include calculating a potential impact of each of a plurality of real copy number variants on a fetal chromosomal abnormality call during the DNA-based noninvasive prenatal screening based on a plurality of real sequencing datasets each including genetic sequencing data of a real reference sample including one of the plurality of real copy number variants. The real copy number variants may be CNVs observed in one or more real test samples. Additionally, determining the at least one threshold feature value utilized in the DNA-based noninvasive prenatal screening may further include determining the at least one threshold feature value based on the calculated potential impacts of both the plurality of synthetic copy number variants and the plurality of real copy number variants on the fetal chromosomal abnormality calls. For example, analysis module 628 in FIG. 6 may determine the at least one threshold feature value based on the calculated potential impacts of both the plurality of synthetic copy number variants and the plurality of real copy number variants on the fetal chromosomal abnormality calls. In at least one embodiment, a threshold percentage of a chromosome covered by at least one maternal CNV may be determined based on correlations between percentages of chromosomes covered by CNVs and z-scores for both the plurality of synthetic sequencing datasets and the plurality of real sequencing datasets. In some embodiments, the impacts of CNVs in specified chromosomes on other chromosomes in the same samples and/or other samples may be determined and/or correlated. For example, sample- and/or batch-level normalization may be utilized to determine effects of CNVs of various chromosomes on other chromosomes in a genome.

In at least one embodiment, the method may further include calculating a potential impact of each of a plurality of real sequencing datasets on a fetal chromosomal abnormality call for a specified chromosome during the DNA-based noninvasive prenatal screening, the real sequencing datasets corresponding to sequenced cfDNA samples determined to have at least one copy number variant in the specified chromosome. For example, abnormality caller module 626 in FIG. 6 may calculate a potential impact of each of a plurality of real sequencing datasets (e.g., sequencing reads obtained from real samples and/or from reference sequences) on a fetal chromosomal abnormality call for the specified chromosome during the DNA-based noninvasive prenatal screening, the non-synthetic chromosome sequencing reads corresponding to sequenced cfDNA samples determined to have at least one copy number variant in the specified chromosome

In some embodiments, determining the at least one threshold feature value utilized in the DNA-based noninvasive prenatal screening may further include determining the at least one threshold feature value based on the calculated potential impacts of both the plurality of synthetic sequencing datasets and the plurality of real sequencing datasets on the fetal chromosomal abnormality calls. For example, analysis module 628 in FIG. 6 may determine the at least one threshold feature value based on the calculated potential impacts of both the plurality of synthetic sequencing datasets and the plurality of real sequencing datasets on the fetal chromosomal abnormality calls.

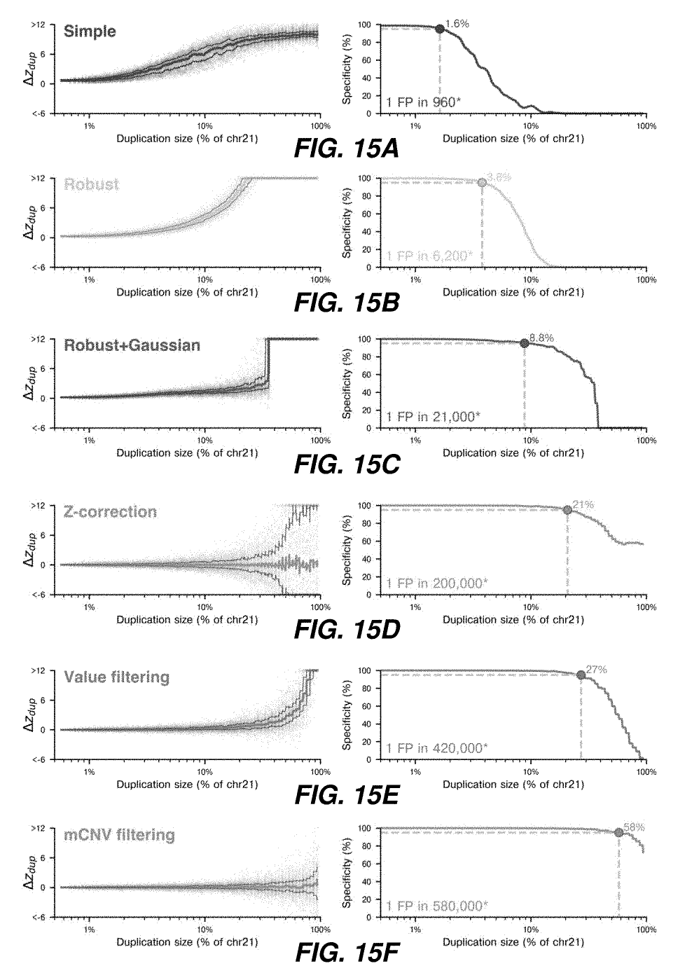

Maternal mCNVs may be common on the chromosomes that noninvasive prenatal screens frequently interrogate (4.5% of patients have mCNV on chromosome 13, 18, or 21) and can cause frequent false positives if not properly neutralized at the algorithmic level. Even noninvasive prenatal tests that share a common sequencing approach (e.g., whole genome sequencing (WGS) of cfDNA) may nevertheless have very different test specificities based on the sophistication of their mCNV handling. Using 87,255 empirical and 30,000 simulated samples, the impact on specificity of various mCNV-mitigation strategies was quantified and a very wide range of values was observed. As will be described in greater detail below, noninvasive prenatal screening approaches described herein, which may exclude bins in mCNVs from downstream calculations, may reduce the expected rate of mCNV-caused false positives nearly 600-fold relative to the algorithms used in the early iterations of WGS-based noninvasive prenatal screens, and which may still be used in practice in clinical laboratories (1 in 580,000 vs. 1 in 960 false positives across trisomies 13, 18, and 21; see, e.g., FIGS. 15A-15F).

Algorithmic analysis approaches tailored to mCNVs, as described herein, may result in better specificity than strategies having robust features but are not mCNV-specific. For example, a “Value-filtering” analysis strategy that excludes genomic bins based on their copy-number values (see, e.g., FIG. 15E) was demonstrated to perform better than a method that simply used robust statistical metrics like the median and IQR (see, e.g., FIG. 15B), as described in greater detail below. “Value filtering” may have a choice of threshold that results in a tradeoff between specificity and sensitivity; a permissive threshold may impair specificity by retaining some bins from mCNVs, whereas an aggressive threshold may lower sensitivity by excluding bins that may not be in mCNVs. This tradeoff may be avoided with an approach that identifies the location of mCNVs and removes only the relevant bins from subsequent analysis. This “mCNV filtering” analysis strategy (see, e.g., FIG. 15F) was shown to have the highest specificity of various analysis strategies considered, with a small ΔZ_{dup} in aggregate across all mCNV sizes, as well as low variance in the individual ΔZ_{dup} values (the “Z-correction” analysis strategy was mCNV-aware but had high variance, which is expected to lower specificity; see, e.g., FIG. 15D). ΔZ_{dup}, which is described in greater detail below, reflects the change in aneuploidy z-score due to a synthetic (i.e., simulated) maternal CNV and is desirably close to 0 with little dispersion across simulations.

Though mostly tailored to retain specificity, mCNV-mitigation approaches may be designed to retain sensitivity for aneuploidies. With the “mCNV filtering” analysis strategy, the small values and variance of ΔZ_{dup} mean that mCNVs may minimally affect the z-score in either direction, suggesting that the filtering process does not compromise sensitivity. The “mCNV filtering” analysis strategy may slightly boost sensitivity by avoiding false negative results in trisomic samples where the aneuploidy-inflated z-score is lowered to normal levels due to a maternal deletion.

Additionally, mCNVs on non-tested chromosomes (i.e., autosomes other than chromosomes 13, 18, or 21)—or even mCNVs in other patient samples—could affect the z-score of a test chromosome. WGS-based noninvasive prenatal screens often involve normalization of NGS read depth to calculate a z-score, and this normalization could include one or many chromosomes, as well as other samples in a background cohort. Robust normalization, including a large number of background samples and/or filtering out mCNVs before normalization, can mitigate spurious z-score changes due to cryptic mCNVs in the analysis pipeline. Expert manual review of both z-scores and bin-level copy-number data across all autosomes can further safeguard against mCNV-caused false positives.

With proper algorithm design and extensive testing that leverages empirical and simulated data, as described herein, high specificity in noninvasive prenatal screens may be possible even in the presence of mCNVs that range widely in size. Importantly, by using the “mCNV-filtering” analysis strategy described herein, achieving robustness to mCNVs—and the corresponding rise in positive predictive value—may not compromise detection of true aneuploidies and, thereby, may preserve both high sensitivity and a low test-failure rate. While the identification and analysis of mCNVs may provide biological insight into the impact of large copy-number variants, mCNV removal upstream of fetal aneuploidy assessment may be important to maintain exemplary test performance, which will be especially critical as noninvasive prenatal screening adoption increases in the wider, general obstetric population.

FIG. 9 is a block diagram of an example system 900 for performing a DNA-based noninvasive prenatal screen on a sample that includes both maternal DNA and fetal DNA. As illustrated in this figure, example system 900 may include an NGS device 910 and one or more modules 922 for performing one or more tasks.

NGS device 910 may include any suitable device or a plurality of devices for isolating polynucleotide fragments and sequencing the isolated polynucleotide sequences. NGS device 910 may include a manual, automated, or semi-automated device for performing any of the NGS procedures and steps as described herein. As will be described in greater detail below, modules 922 may include an abnormality caller module 924 that identifies abnormalities (e.g., aneuploidies, microdeletions, microduplications, etc.) in fetal DNA and an analysis module 926 that determines CNVs in maternal chromosomes and identifies likely true and/or false fetal chromosomal abnormality determinations based on threshold feature values. Modules 922 may also include a correction module 928 that adjusts sequencing read quantities and/or z-scores to compensate for CNVs.

In certain embodiments, one or more of modules 922 in FIG. 9 may represent one or more software applications or programs that, when executed by a computing device, may cause the computing device to perform one or more tasks. For example, and as will be described in greater detail below, one or more of modules 922 may represent modules stored and configured to run on one or more computing devices. One or more of modules 922 in FIG. 9 may also represent all or portions of one or more special-purpose computers configured to perform one or more tasks. NGS device 910 may also include one or more software applications or programs that, when executed by a computing device, may cause the computing device to perform one or more tasks.

As illustrated in FIG. 9, example system 900 may also include one or more memory devices, such as memory 920. Memory 920 generally represents any type or form of volatile or non-volatile storage device or medium capable of storing data and/or computer-readable instructions. In one example, memory 920 may store, load, and/or maintain one or more of modules 922 and/or one or more modules of NGS device 910. Examples of memory 920 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 9, example system 900 may also include one or more physical processors, such as physical processor 930. Physical processor 930 generally represents any type or form of hardware-implemented processing unit capable of interpreting and/or executing computer-readable instructions. In one example, physical processor 930 may access and/or modify one or more of modules 922 stored in memory 920 and/or one or modules of NGS device 910. Additionally or alternatively, physical processor 930 may execute one or more of modules 922 to facilitate performing DNA-based noninvasive prenatal screens on a sample that includes both maternal DNA and fetal DNA. Examples of physical processor 930 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

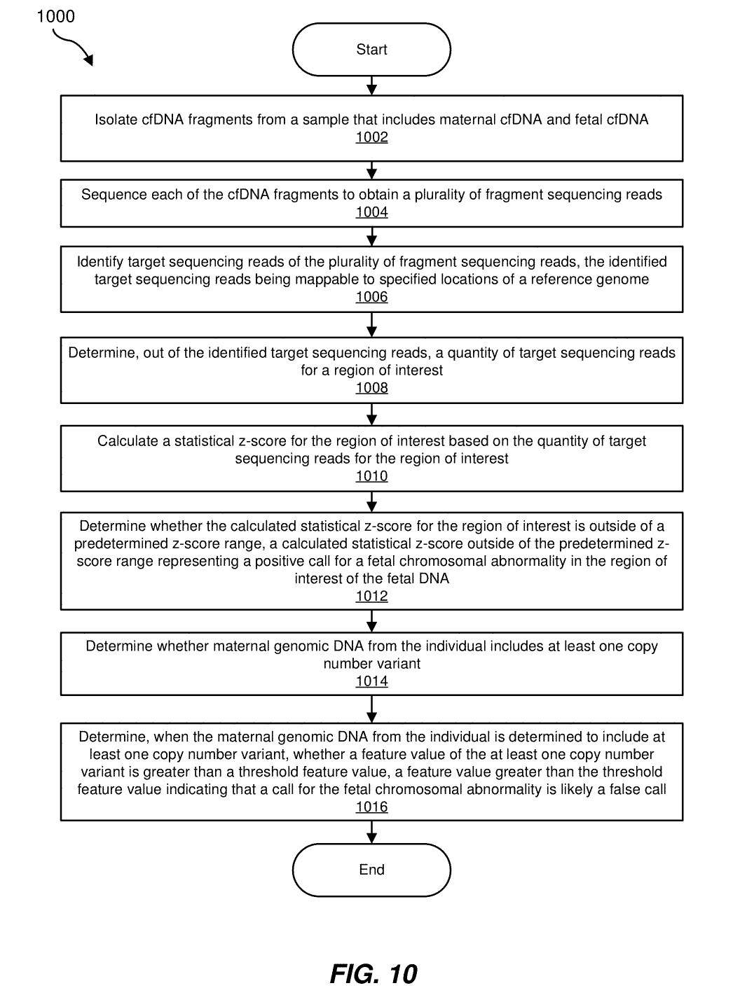

FIG. 10 is a flow diagram of an exemplary method 1000 for performing a DNA-based noninvasive prenatal screen on a sample that includes both maternal DNA and fetal DNA. Some of the steps shown in FIG. 10 may be performed by any suitable computer-executable code and/or computing system, including system 900 in FIG. 9. In one example, some of the steps shown in FIG. 10 may represent an algorithm whose structure includes and/or is represented by multiple sub-steps, examples of which will be provided in greater detail below.

As illustrated in FIG. 10, at step 1002, one or more of the systems described herein may isolate cfDNA fragments from a sample that includes both maternal cfDNA and fetal cfDNA. For example, NGS device 910 in FIG. 9 may isolate cfDNA fragments from a sample using any of the techniques described herein and/or using any suitable DNA fragment isolation technique, without limitation. In some embodiments, low-depth genome sequencing or high-depth whole-genome sequencing may be used to isolate and enrich cfDNA fragments. In some embodiments, target polynucleotide fragments may be isolated and enriched using probes, such as hybrid-capture probes, directed to specified polynucleotide sequences. In at least one embodiment, amplicon sequencing may be used as an alternative to hybrid-capture as a means to achieve targeted sequencing. Any high-throughput quantitative data may be used, be it from NGS, microarrays, and/or any other high-throughput quantitative molecular biology technique.

At step 1004, one or more of the systems described herein may sequence each of the cfDNA fragments to obtain a plurality of fragment sequencing reads. For example, NGS device 910 in FIG. 9 may sequence the plurality of cfDNA fragments to obtain a plurality of fragment sequencing reads using any of the techniques described herein and/or any suitable sequencing technique, without limitation. For example, low-depth genome sequencing or high-depth whole-genome sequencing may be used to isolate and enrich cfDNA fragments. Any high-throughput quantitative data may be used, be it from NGS, microarrays, and/or any other high-throughput quantitative molecular biology technique.

At step 1006, one or more of the systems described herein may identify target sequencing reads of the plurality of fragment sequencing reads, the identified target sequencing reads being mappable to specified locations of a reference genome. For example, abnormality caller module 924 in FIG. 9 may identify target sequencing reads of the plurality of fragment sequencing reads, the identified target sequencing reads being corresponding to identified target sequences of a reference genome, including all chromosomes in the genome. In at least one embodiment, the target sequencing reads may be unique reads that each match only a single point on a reference genome. In some embodiments, mappable target sequencing reads may be utilized by abnormality caller module 924, and un-mappable or un-alignable sequencing reads may be ignored or discarded.

In at least one embodiment, one or more of the systems described herein may identify target sequencing reads by aligning cfDNA fragment sequence to a reference sequence. For example, abnormality caller module 924 in FIG. 9 may align fragment sequencing reads of the plurality of fragment sequencing reads to a reference sequence. Alignment may generally involve placing one sequence along another sequence, iteratively introducing gaps along each sequence, scoring how well the two sequences match, and preferably repeating for various positions along the reference. The best-scoring match may be deemed to be the alignment and represents an inference about the degree of relationship between the sequences. In some embodiments, a reference sequence to which sequencing reads are compared may be a reference genome, such as the genome of a member of the same species as the subject.

The alignment data output may be provided in the format of a computer file. In certain embodiments, the output is a FASTA file, VCF file, text file, or an XML file containing sequence data such as a sequence of the nucleic acid aligned to a sequence of the reference genome. In other embodiments, the output contains coordinates or a string describing one or more mutations in the subject nucleic acid relative to the reference genome. Alignment strings known in the art include Simple UnGapped Alignment Report (SUGAR), Verbose Useful Labeled Gapped Alignment Report (VULGAR), and Compact Idiosyncratic Gapped Alignment Report (CIGAR) (Ning, Z., et al., Genome Research 11(10):1725-9 (2001)). In some embodiments, the output is a sequence alignment—such as, for example, a sequence alignment map (SAM) or binary alignment map (BAM) file—including a CIGAR string (the SAM format is described, e.g., in Li, et al., The Sequence Alignment/Map format and SAMtools, Bioinformatics, 2009, 25(16):2078-9). In some embodiments, CIGAR displays or includes gapped alignments one-per-line. CIGAR is a compressed pairwise alignment format reported as a CIGAR string. In some embodiments, a second alignment using a second algorithm may be performed after a first alignment using a first algorithm. In some examples, filtering based on mapping quality may be optionally performed.

At step 1008, one or more of the systems described herein may determine, out of the identified target sequencing reads, a quantity of target sequencing reads for a region of interest. For example, abnormality caller module 924 in FIG. 9 may determine, out of the identified target sequencing reads, a quantity of target sequencing reads for a region of interest, such as target sequencing reads corresponding to chromosome 13, 18, 21, X, Y, and/or any other chromosome of interest or portion thereof. In at least one embodiment, determining the quantity of target sequencing reads for the region of interest may include determining a number of target sequencing reads in each of a plurality of bins corresponding to the region of interest (see, e.g., FIGS. 3-5).

At step 1010, one or more of the systems described herein may calculate a statistical z-score for the region of interest based on the quantity of target sequencing reads for the region of interest. For example, abnormality caller module 924 in FIG. 9 may calculate a statistical z-score for the region of interest based on the quantity of target sequencing reads for the region of interest according to any of the techniques described herein.

In some embodiments, calculating the statistical z-score for the specified chromosome may include calculating a percentage of the quantity of the target sequencing reads for the specified chromosome relative to the total quantity of target sequencing reads. In some embodiments, abnormality caller module 924 may calculate a z-score (i.e., z_{cfDNA}) using the percentage of the quantity of the target sequencing reads for the specified chromosome relative to the total quantity of target sequencing reads according to the following Equation (2):

$${Z}_{cfDNA} = \frac{{\%}_{cfDNA} - Med {\%}_{reference}}{{MAD}_{reference}} \qquad ( 2 )$$

where %_{cfDNA} is the percentage of the quantity of the target sequencing reads for the specified chromosome with respect to the total quantity of target sequencing reads for the genome, Med%_{reference} is the average percentage of the target sequencing reads for a sample population and/or reference population for the specified chromosome, and MAD_{reference} is an average absolute deviation for the sample population and/or reference population for the specified chromosome. Additionally or alternatively, any suitable technique for calculating a z-score, or any other value of statistical significance, as described herein may be utilized. In at least one embodiment, calculating the statistical z-score for the region of interest based on the quantity of target sequencing reads for the region of interest may include calculating the statistical z-score for the region of interest based on an average number of target sequencing reads per bin for a plurality of bins corresponding to the region of interest. For example, the average number reads per bin for a background based on reference samples may be subtracted from the average number reads per bin for the sample and the total may be divided by the average absolute deviation (or dispersion) of the background.

At step 1012, one or more of the systems described herein may determine whether the calculated statistical z-score for the region of interest is outside of a predetermined z-score range, a calculated statistical z-score outside of the predetermined z-score range representing a positive call for a fetal chromosomal abnormality in the region of interest of the fetal DNA. For example, abnormality caller module 924 in FIG. 9 may determine whether the calculated statistical z-score for the region of interest is outside of a predetermined z-score range, with a calculated statistical z-score outside of the predetermined z-score range representing a positive call for a fetal chromosomal abnormality in the region of interest of the fetal DNA.

In some embodiments, abnormality caller module 924 may use a specified range of z-scores, with the upper limit of the specified range being a threshold value for a fetal aneuploidy call. In some embodiments, a range of z-scores may range from about −6 to about 6, about −5 to about 5, about −4 to about 4, about −3.5 to about 3.5, about −3 to about 3, about −2.5 to about 2.5, or about −2 to about 2. A calculated statistical z-score greater than an upper limit of at least one of these ranges may be determined to correlate to a likely fetal aneuploidy (e.g., trisomy) and a z-score below a lower limit of at least one of these ranges may be determined to correlate to a likely fetal aneuploidy (e.g., monosomy). Accordingly, abnormality caller module 924 may indicate a positive call for fetal aneuploidy based on a z-score greater than the upper limit or less than a lower limit of the specified range.

In some embodiments, the threshold feature z-score value and/or range may be a z-score value and/or range that has been determined based on analysis of a plurality of synthetic sequencing datasets and/or a plurality of real sequencing datasets. The threshold z-score value and/or range may be determined in accordance with any of the systems and methods disclosed herein. At step 1014, one or more of the systems described herein may determine whether maternal genomic DNA from the individual includes at least one copy number variant. For example, when the calculated statistical z-score for the specified chromosome is determined, based on the statistical z-score for the specified chromosome, to be greater than a threshold statistical z-score, analysis module 926 in FIG. 9 may determine whether maternal genomic DNA from the individual includes at least one copy number variant. In some embodiments, analysis module 926 in FIG. 9 may determine whether maternal genomic DNA from the individual includes at least one copy number variant regardless of whether the calculated z-score value is determined to be greater than a threshold statistical z-score.

Analysis module 926 may determine whether maternal genomic DNA from the individual includes at least one copy number variant in a variety of ways. In one example, when abnormality caller 924 returns a positive call indicating a fetal chromosomal abnormality (e.g., trisomy, monosomy, microdeletion, microduplication, etc.) during noninvasive prenatal screening based on the calculated statistical z-score being outside of a specified range, quality-control metrics and/or manual review, such as computer-assisted manual review, of the sequenced cfDNA sample may be utilized by analysis module 926 to identify a maternal CNV, such as at least one duplication and/or deletion, in the chromosome for which the fetal aneuploidy was called and/or in another chromosome. Any suitable analysis of the cfDNA sample and/or data obtained from the cfDNA sample (e.g., sequencing data) may be utilized to identify the maternal CNV, without limitation. Maternal CNVs may be identified based on the sample and/or corresponding data utilized to obtain the z-score and make the aneuploidy call. In some embodiments, an additional sample may be obtained from the individual or a stored sample may be retested if necessary to confirm the presence or absence of a maternal CNV. For example, genomic DNA may be extracted from a stored blood or saliva sample and retested to confirm the presence or absence of a maternal CNV. In at least one embodiment, a sample of the maternal DNA may have been obtained and/or sequenced prior to pregnancy and/or prior to obtaining the cfDNA sample, providing maternal sequencing data for the maternal DNA that does not include fetal DNA and/or a much lower quantity of fetal DNA. In some embodiment, an extracted genomic DNA sample obtained during pregnancy (e.g., from blood, saliva, etc.) may include a minimal quantity of fetal DNA.

In some embodiments, a copy caller may be utilized to identify one or more maternal CNVs and/or potential maternal CNVs. For example, a hidden Markov model (HMM) (see, e.g., Boufounos, P., et al., Journ. of the Franklin Inst. 341: 23-36 (2004)), a Gaussian mixture model (see, e.g., U.S. Patent Application No. 62/452,974), a breakpoint caller (see, e.g., U.S. Patent Application No. 62/452,985), and/or any other suitable technique may be utilized to identify one or more CNVs in the specified chromosome, without limitation. Various systems and methods that may be utilized for identifying CNVs may be found, for example, in U.S. Pat. No. 9,092,401, U.S. Patent Publication No. 2016/0140289, U.S. Patent Publication No. 2015/0205914, and U.S. Patent Publication No. 2016/0188793. An operator of system 900 may manually initiate and/or perform at least a portion of the CNV determination review utilizing abnormality caller 924.

In some embodiments, one or more of the systems described herein may calculate read depths for base positions of the plurality of target polynucleotide fragments relative to each base position of a reference sequence. For example, analysis module 926 in FIG. 9 may calculate read depths (i.e., depth signal) for base positions of the plurality of target polynucleotide fragments relative to each base position of the reference sequence. Single-end or paired-end reading may be used to determine read depths. The depth of coverage is a measure of the number of times that a specific genomic site is sequenced during a sequencing run. In some embodiments, read depths may be determined and/or normalized based on GC content at each base position of the reference sequence and may be expressed as the number of counts at each base position. In at least one embodiment, low-depth genome sequencing may be utilized and depth signals may be binned. In some embodiments, one or more of the systems described herein may calculate copy number likelihoods for base positions of the reference sequence based on read depths. For example, analysis module 926 in FIG. 9 may calculate copy number likelihoods for each base position of the reference sequence based on the read depths.

At step 1016, one or more of the systems described herein may determine, when the maternal genomic DNA from the individual is determined to include at least one copy number variant, whether a feature value of the at least one copy number variant is greater than a threshold feature value, a feature value greater than the threshold feature value indicating that a call for the fetal chromosomal abnormality is likely a false call. For example, when a maternal CNV, or likely maternal CNV, is identified in one or more chromosomes (including the specified chromosome and/or one or more other chromosomes), analysis module 926 in FIG. 9 may determine whether a feature value of the at least one CNV is greater than a threshold feature value. In at least one embodiment, the region of interest and the at least one CNV may be located in the same chromosome. Alternatively, the region of interest and the at least one CNV may be located in different chromosomes.

In some embodiments, when a maternal CNV, or likely maternal CNV, is identified in one or more chromosomes (including the specified chromosome and/or one or more other chromosomes), the size of the CNV may be calculated. The threshold feature value may be utilized to determine whether the CNV likely resulted in a false fetal chromosomal abnormality call. For example, if the CNV size is above a predetermined threshold CNV size, a positive fetal chromosomal abnormality call may be determined to likely be a false-positive call. However, if the CNV size is below the threshold CNV size, a positive fetal chromosomal abnormality call may be determined to likely be a true-positive call. In some embodiments, the CNV type (e.g., duplication or deletion) may be determined. If, for example, the CNV includes at least one duplication in the specified chromosome, the size of the at least one duplication (e.g., CNV base pair length and/or percentage of chromosome covered by the CNV) may be determined for the at least one duplication (i.e., size of the at least one duplication or combined size of multiple duplications). If the length of the CNV(s) and/or percentage of chromosome covered by the CNV(s) exceeds a predetermined threshold length and/or percentage of chromosome, then a positive fetal chromosomal abnormality call may be determined to likely be a false-positive call. The threshold feature may comprise any CNV suitable length and/or percentage of chromosome covered by the CNV, without limitation. For example, the threshold percentage of a chromosome covered by the at least one CNV may include a percentage of about 4% or more (e.g., about 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30% or more of the chromosome covered by the at least one CNV).

Such a determination may result in more accurate true-positive and false-positive fetal chromosomal abnormality determinations during noninvasive prenatal screening. Additionally, identifying likely false chromosomal abnormality calls, such as false-positive chromosomal abnormality calls, during noninvasive prenatal screening may enable expectant mothers to avoid unnecessarily undertaking invasive follow-up testing to confirm the existence of a fetal chromosomal abnormality in cases where the screening produces the likely false-positive call due to a maternal CNV.

In some embodiments, the present systems and methods may additionally or alternatively be utilized to determine whether negative chromosomal abnormality calls are true-negative or false-negative calls. For example, when an abnormality caller 924 returns a negative call for fetal chromosomal abnormality in a specified chromosome during noninvasive prenatal screening based on the calculated statistical z-score being within a specified range, quality-control metrics and/or manual review, such as computer-assisted manual review, of the sequenced cfDNA sample may be utilized to identify a maternal CNV, such as a deletion, in the chromosome for which the fetal chromosomal abnormality was called. In at least one embodiment, review of the sample may be performed when the z-score resulting in the negative call is within a specified sub-range, such as a sub-range adjacent to the upper limit or lower limit of the specified z-score range. Such a sub-range may represent a sub-range of z-scores that, while is not greater than an upper z-score value or less than a lower z-score value of a predetermined range utilized to make a positive chromosomal abnormality call, are nonetheless within sufficiently close proximity to an upper or lower z-score value to merit further review for a potential false-negative call. For example, a sub-range of z-scores may range from a z-score of about 1, about 1.5, about 2, about 2.5 about 3, about 3.5, or about 4, about 4.5, about 5, or about 5.5, to an upper limit, or threshold z-score value (e.g., about 6, about 5, about 4, about 3.5, about 3, about 2.5, or about 2). Additionally or alternatively, a sub-range of z-scores may range from a z-score of about −1, about −1.5, about −2, about −2.5 about −3, about −3.5, or about −4, about −4.5, about −5, or about −5.5, to a lower limit, or threshold z-score value (e.g., about −6, about −5, about −4, about −3.5, about −3, about −2.5, or about −2). A calculated statistical z-score within the specified sub-range may be determined to correlate to a potential false-negative chromosomal abnormality call.

In some embodiments, when a z-score is calculated and determined to be within a sub-range indicating a potential false-negative chromosomal abnormality call, analysis module 926 may determine whether maternal genomic DNA from the individual includes at least one copy number variant in the specified chromosome, such as one or more deletions, in a variety of ways. For example, when an abnormality caller 924 returns a negative chromosomal abnormality call for the specified chromosome, quality-control metrics and/or manual review, such as computer-assisted manual review, of the sequenced cfDNA sample may be utilized to identify a maternal CNV, such as at least one deletion. Any suitable analysis of the cfDNA sample and/or data obtained from the cfDNA sample (e.g., sequencing data) may be utilized to identify the maternal CNV as described herein, without limitation.

In at least one embodiment, when a CNV or potential CNV, such as at least one deletion, is identified, analysis module 926 in FIG. 9 may determine whether a feature value of the at least one CNV is greater than a threshold feature value (e.g., any of the threshold feature values described above). For example, the size of the CNV may be calculated in accordance with any of the techniques described herein. The threshold feature value may be utilized to determine whether the CNV likely resulted in a false-negative fetal chromosomal abnormality call. For example, if the CNV size is above a predetermined threshold CNV size, the negative fetal chromosomal abnormality call may be determined to likely be a false-negative call. However, if the CNV size is below the threshold CNV size, the negative fetal chromosomal abnormality call may be determined to likely be a true-negative call. Such a determination may result in more accurate true-negative and false-negative chromosomal abnormality determinations during noninvasive prenatal screening. According to some embodiments, the threshold feature value may be determined based on analysis of a plurality of synthetic sequencing datasets and/or real sequencing datasets in accordance with any of the systems and methods described herein (see, e.g., FIGS. 6 and 7).

According to some embodiments, the method may further include adjusting, when the feature value of the at least one copy number variant is greater than the threshold feature value, a quantity of target sequencing reads in at least one variant region corresponding to the at least one copy number variant to generate an adjusted set of target sequencing reads. For example, correction module 928 in FIG. 9 may adjust a quantity of target sequencing reads in at least one variant region corresponding to the at least one copy number variant to generate an adjusted set of target sequencing reads. For example, bin values in the variant region may be adjusted to correspond to a copy number in regions of a sample outside the variant region and/or to correspond to a copy number in corresponding bins in background samples.

In some embodiments, adjusting the quantity of target sequencing reads in the at least one variant region to generate the adjusted set of target sequencing reads may include increasing and/or decreasing the number of target sequencing reads in the at least one variant region corresponding to the at least one CNV. According to some embodiments, adjusting the quantity of target sequencing reads in the at least one variant region to generate the adjusted set of target sequencing reads may include removing target sequencing reads in the at least one variant region. In some embodiments, correction module 928 may utilize various techniques catered to a specific cfDNA sample or type of cfDNA sample. In some embodiments, the quantity of target sequencing reads may be adjusted by reducing or increasing target sequencing read counts in one or more bins corresponding to the at least one CNV. In at least one example, correction module 928 may additionally or alternatively ignore certain sequencing read bins based on specified criteria. For example, outlier bins, such as bins including too many or too few reads, may be removed or ignored (e.g., only bins having sequencing reads in the 5^{th} to 95^{th} percentile based on read counts may be analyzed). Corresponding bins in background samples may also be removed or ignored. A number of bins removed may be selected to ensure that a resulting fetal chromosomal abnormality call utilizing the adjusted set of target sequencing reads maintains a desired level specificity.

The method may also include generating an adjusted quantity of target sequencing reads for the region of interest based on the adjusted set of target sequencing reads. For example, correction module 928 in FIG. 9 may generate an adjusted quantity of target sequencing reads for the region of interest based on the adjusted set of target sequencing reads and calculate an adjusted statistical z-score for the region of interest based on the adjusted quantity of target sequencing reads. In at least one embodiment, generating the adjusted quantity of target sequencing reads for the region of interest may include replacing sequencing reads of the quantity of target sequencing reads in the at least one variant region with the adjusted set of target sequencing reads.

In some embodiments, the method may include calculating an adjusted statistical z-score for the region of interest based on the adjusted quantity of target sequencing reads. For example, abnormality caller module 924 in FIG. 9 may calculate an adjusted statistical z-score for the region of interest based on the adjusted quantity of target sequencing reads. The method may additionally include determining whether the adjusted statistical z-score for the region of interest is outside of the predetermined z-score range. For example, abnormality caller module 924 in FIG. 9 may determine whether the adjusted statistical z-score for the region of interest is outside of the predetermined z-score range described above.

In some embodiments, the method may further include calculating, when the feature value of the at least one copy number variant is greater than the threshold feature value, an adjusted statistical z-score for the region of interest and determining whether the adjusted statistical z-score for the region of interest is outside of the predetermined z-score range. For example, correction module 928 in FIG. 9 may calculate an adjusted statistical z-score for the region of interest. Correction module 928 may, for example, adjust the calculated statistical z-score based on the feature value of the at least one copy number variant. For example, correction module 928 may adjust the statistical z-score for the region of interest based on an estimated or potential impact of an identified CNV based on the size of the CNV (e.g., CNV length and/or percentage of the corresponding chromosome covered by the CNV). By way of illustration, a maternal CNV, such as a duplication, covering about 5% of a chromosome may be estimated to, for example, result in a z-score increase of approximately 6 units based on simulations of CNVs covering 5% of the chromosome. Accordingly, correction module 928 may subtract 6 units from the calculated z-score for the chromosome including the maternal CNV. Such a z-score correction factor might be specific to a chromosome, to a range of fetal fractions, or to a mode of transmission of the CNV (e.g., whether the fetus inherited the CNV or not). Abnormality caller module 924 in FIG. 9 may then, for example, determine whether the adjusted statistical z-score for the region of interest is outside of the predetermined z-score range.

Any of the above-described adjustments to real sequencing reads and/or statistical z-scores, such as any of the above-described functionalities performed by correction module 928 in FIG. 9, may also be applied by, for example, correction module 630 to adjust synthetic numbers of sequencing reads in synthetic sequencing datasets and/or corresponding statistical z-scores (see, e.g., FIGS. 6 and 7).

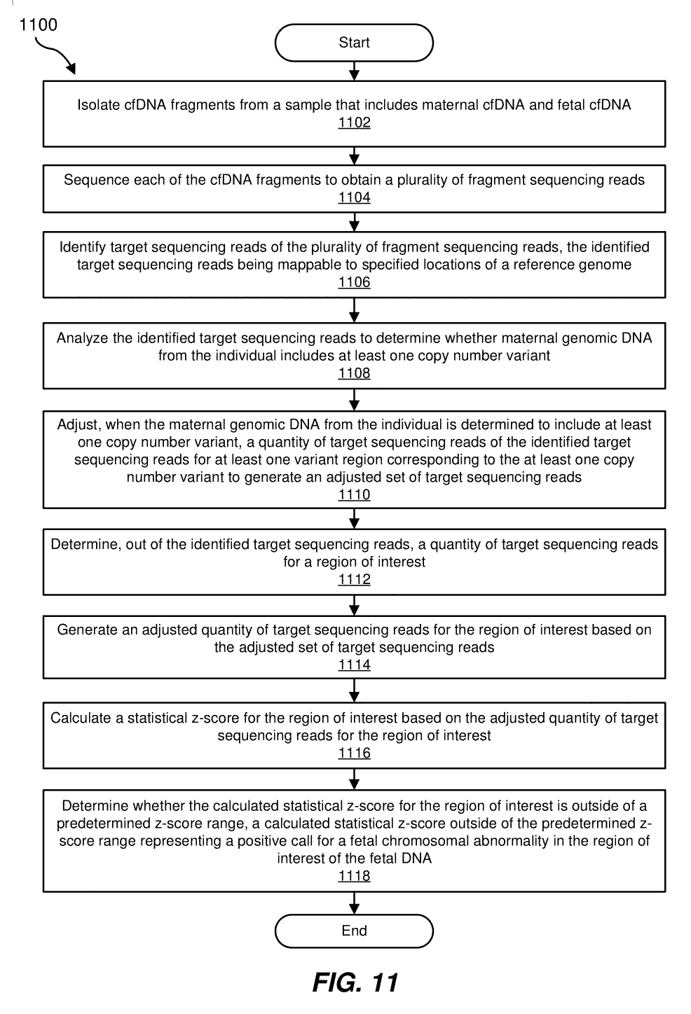

FIG. 11 is a flow diagram of an exemplary method 1100 for performing a DNA-based noninvasive prenatal screen on a sample that includes both maternal DNA and fetal DNA. Some of the steps shown in FIG. 11 may be performed by any suitable computer-executable code and/or computing system, including system 900 in FIG. 9. In one example, some of the steps shown in FIG. 11 may represent an algorithm whose structure includes and/or is represented by multiple sub-steps, examples of which will be provided in greater detail below.

As illustrated in FIG. 11, at step 1102, one or more of the systems described herein may isolate cfDNA fragments from a sample that includes both maternal cfDNA and fetal cfDNA. At step 1104, one or more of the systems described herein may sequence each of the cfDNA fragments to obtain a plurality of fragment sequencing reads. At step 1106, one or more of the systems described herein may identify target sequencing reads of the plurality of fragment sequencing reads, the identified target sequencing reads being mappable to specified locations of a reference genome. At step 1108, one or more of the systems described herein may analyze the identified target sequencing reads to determine whether maternal genomic DNA from the individual includes at least one copy number variant.

At step 1110, one or more of the systems described herein may adjust, when the maternal genomic DNA from the individual is determined to include at least one copy number variant, a quantity of target sequencing reads of the identified target sequencing reads in at least one variant region corresponding to the at least one copy number variant to generate an adjusted set of target sequencing reads. At step 1112, one or more of the systems described herein may determine, out of the identified target sequencing reads, a quantity of target sequencing reads for a region of interest.

At step 1114, one or more of the systems described herein may generate an adjusted quantity of target sequencing reads for the region of interest based on the adjusted set of target sequencing reads. At step 1116, one or more of the systems described herein may calculate a statistical z-score for the region of interest based on the adjusted quantity of target sequencing reads for the region of interest. At step 1118 one or more of the systems described herein may determine whether the calculated statistical z-score for the region of interest is outside of a predetermined z-score range, a calculated statistical z-score outside of the predetermined z-score range representing a positive call for a fetal chromosomal abnormality in the region of interest of the fetal DNA

FIG. 12 is a block diagram of an example computing system 1210 capable of implementing at least a portion of one or more of the embodiments described and/or illustrated herein. For example, all or a portion of computing system 1210 may perform and/or be a means for performing, either alone or in combination with other elements, one or more of the steps described herein (such as one or more of the steps illustrated in FIGS. 7, 10, and 11). All or a portion of computing system 1210 may also perform and/or be a means for performing any other steps, methods, or processes described and/or illustrated herein.

Computing system 1210 broadly represents any single or multi-processor computing device or system capable of executing computer-readable instructions. Examples of computing system 1210 include, without limitation, workstations, laptops, client-side terminals, servers, distributed computing systems, handheld devices, or any other computing system or device. In its most basic configuration, computing system 1210 may include at least one processor 1214 and a system memory 1216.

Processor 1214 generally represents any type or form of physical processing unit (e.g., a hardware-implemented central processing unit) capable of processing data or interpreting and executing instructions. In certain embodiments, processor 1214 may receive instructions from a software application or module. These instructions may cause processor 1214 to perform the functions of one or more of the example embodiments described and/or illustrated herein.

System memory 1216 generally represents any type or form of volatile or non-volatile storage device or medium capable of storing data and/or other computer-readable instructions. Examples of system memory 1216 include, without limitation, Random Access Memory (RAM), Read Only Memory (ROM), flash memory, or any other suitable memory device. Although not required, in certain embodiments computing system 1210 may include both a volatile memory unit (such as, for example, system memory 1216) and a non-volatile storage device (such as, for example, primary storage device 1232, as described in detail below). In one example, one or more of modules 622 from FIG. 6 and/or one or more of modules 922 from FIG. 9 may be loaded into system memory 1216.

In some examples, system memory 1216 may store and/or load an operating system 1240 for execution by processor 1214. In one example, operating system 1240 may include and/or represent software that manages computer hardware and software resources and/or provides common services to computer programs and/or applications on computing system 1210. Examples of operating system 1240 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 1210 may also include one or more components or elements in addition to processor 1214 and system memory 1216. For example, as illustrated in FIG. 12, computing system 1210 may include a memory controller 1218, an Input/Output (I/O) controller 1220, and a communication interface 1222, each of which may be interconnected via a communication infrastructure 1212. Communication infrastructure 1212 generally represents any type or form of infrastructure capable of facilitating communication between one or more components of a computing device. Examples of communication infrastructure 1212 include, without limitation, a communication bus (such as an Industry Standard Architecture (ISA), Peripheral Component Interconnect (PCI), PCI Express (PCIe), or similar bus) and a network.

Memory controller 1218 generally represents any type or form of device capable of handling memory or data or controlling communication between one or more components of computing system 1210. For example, in certain embodiments memory controller 1218 may control communication between processor 1214, system memory 1216, and I/O controller 1220 via communication infrastructure 1212.

I/O controller 1220 generally represents any type or form of module capable of coordinating and/or controlling the input and output functions of a computing device. For example, in certain embodiments I/O controller 1220 may control or facilitate transfer of data between one or more elements of computing system 1210, such as processor 1214, system memory 1216, communication interface 1222, display adapter 1226, input interface 1230, and storage interface 1234.

As illustrated in FIG. 12, computing system 1210 may also include at least one display device 1224 coupled to I/O controller 1220 via a display adapter 1226. Display device 1224 generally represents any type or form of device capable of visually displaying information forwarded by display adapter 1226. Similarly, display adapter 1226 generally represents any type or form of device configured to forward graphics, text, and other data from communication infrastructure 1212 (or from a frame buffer, as known in the art) for display on display device 1224.

As illustrated in FIG. 12, example computing system 1210 may also include at least one input device 1228 coupled to I/O controller 1220 via an input interface 1230. Input device 1228 generally represents any type or form of input device capable of providing input, either computer or human generated, to example computing system 1210. Examples of input device 1228 include, without limitation, a keyboard, a pointing device, a speech recognition device, variations or combinations of one or more of the same, and/or any other input device.

Additionally or alternatively, example computing system 1210 may include additional I/O devices. For example, example computing system 1210 may include I/O device 1236. In this example, I/O device 1236 may include and/or represent a user interface that facilitates human interaction with computing system 1210. Examples of I/O device 1236 include, without limitation, a computer mouse, a keyboard, a monitor, a printer, a modem, a camera, a scanner, a microphone, a touchscreen device, variations or combinations of one or more of the same, and/or any other I/O device.

Communication interface 1222 broadly represents any type or form of communication device or adapter capable of facilitating communication between example computing system 1210 and one or more additional devices. For example, in certain embodiments communication interface 1222 may facilitate communication between computing system 1210 and a private or public network including additional computing systems. Examples of communication interface 1222 include, without limitation, a wired network interface (such as a network interface card), a wireless network interface (such as a wireless network interface card), a modem, and any other suitable interface. In at least one embodiment, communication interface 1222 may provide a direct connection to a remote server via a direct link to a network, such as the Internet. Communication interface 1222 may also indirectly provide such a connection through, for example, a local area network (such as an Ethernet network), a personal area network, a telephone or cable network, a cellular telephone connection, a satellite data connection, or any other suitable connection.

In certain embodiments, communication interface 1222 may also represent a host adapter configured to facilitate communication between computing system 1210 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 1222 may also allow computing system 1210 to engage in distributed or remote computing. For example, communication interface 1222 may receive instructions from a remote device or send instructions to a remote device for execution.

In some examples, system memory 1216 may store and/or load a network communication program 1238 for execution by processor 1214. In one example, network communication program 1238 may include and/or represent software that enables computing system 1210 to establish a network connection 1242 with another computing system (not illustrated in FIG. 12) and/or communicate with the other computing system by way of communication interface 1222. In this example, network communication program 1238 may direct the flow of outgoing traffic that is sent to the other computing system via network connection 1242. Additionally or alternatively, network communication program 1238 may direct the processing of incoming traffic that is received from the other computing system via network connection 1242 in connection with processor 1214.

Although not illustrated in this way in FIG. 12, network communication program 1238 may alternatively be stored and/or loaded in communication interface 1222. For example, network communication program 1238 may include and/or represent at least a portion of software and/or firmware that is executed by a processor and/or Application Specific Integrated Circuit (ASIC) incorporated in communication interface 1222.

As illustrated in FIG. 12, example computing system 1210 may also include a primary storage device 1232 and a backup storage device 1233 coupled to communication infrastructure 1212 via a storage interface 1234. Storage devices 1232 and 1233 generally represent any type or form of storage device or medium capable of storing data and/or other computer-readable instructions. For example, storage devices 1232 and 1233 may be a magnetic disk drive (e.g., a so-called hard drive), a solid state drive, a floppy disk drive, a magnetic tape drive, an optical disk drive, a flash drive, or the like. Storage interface 1234 generally represents any type or form of interface or device for transferring data between storage devices 1232 and 1233 and other components of computing system 1210.

In certain embodiments, storage devices 1232 and 1233 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 1232 and 1233 may also include other similar structures or devices for allowing computer software, data, or other computer-readable instructions to be loaded into computing system 1210. For example, storage devices 1232 and 1233 may be configured to read and write software, data, or other computer-readable information. Storage devices 1232 and 1233 may also be a part of computing system 1210 or may be a separate device accessed through other interface systems.

Many other devices or subsystems may be connected to computing system 1210. Conversely, all of the components and devices illustrated in FIG. 12 need not be present to practice the embodiments described and/or illustrated herein. The devices and subsystems referenced above may also be interconnected in different ways from that shown in FIG. 12. Computing system 1210 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 1210. All or a portion of the computer program stored on the computer-readable medium may then be stored in system memory 1216 and/or various portions of storage devices 1232 and 1233. When executed by processor 1214, a computer program loaded into computing system 1210 may cause processor 1214 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 1210 may be configured as an Application Specific Integrated Circuit (ASIC) adapted to implement one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

### EXAMPLES

The present invention is described in further detail in the following examples which are not in any way intended to limit the scope of the invention as claimed. The attached figures are meant to be considered as integral parts of the specification and description of the invention. The following examples are offered to illustrate, but not to limit the claimed invention.

### Example 1

### Z-Scores Correlated to Percentage of Chromosome Covered by Duplications

A plurality of real sequencing datasets was obtained from 87,255 real maternal cfDNA samples. Additionally, a plurality of synthetic sequencing datasets for 30,887 synthetic maternal cfDNA samples was generated in accordance with systems and methods described herein. A z-score for a chromosomal aneuploidy was calculated for chromosomes harboring mCNV duplications in the plurality of real sequencing datasets and the plurality of synthetic sequencing datasets.

FIG. 13 shows a distribution of z-scores for chromosomes having at least one mCNV duplication identified from the datasets for the plurality of real samples and the plurality of synthetic samples. 38,102 chromosomes having duplications were identified in the datasets for the plurality of real samples and 31,114 chromosomes having duplications were identified in the datasets for the plurality of synthetic samples. Each of the z-scores (Y-axis) for the plurality of chromosomes having identified duplications for the real samples and the synthetic samples was respectively plotted relative to the corresponding percentage (X-axis) of the chromosome occupied by the at least one maternal sequence duplication. An upper reference z-score of 3 is shown in FIG. 13. A solid line representing a rolling median of 200 adjacent data points is also shown in FIG. 13. The thinner, darker trace represents observed mCNVs and the thicker, lighter trace represents synthetic mCNVs.

Correlations between z-scores and percentages of respective chromosomes occupied by maternal copy number variants (duplications and deletions) as illustrated, for example, in FIG. 13, may be utilized to determine threshold CNV lengths (in terms of percentage of chromosome occupied by the CNV) for deletions and duplications. Because CNVs spanning more than 10 Mb are empirically rare, synthetic sequencing datasets may be used to determine the impact of larger CNVs and to more accurately determine a suitable threshold CNV length. A threshold CNV length for maternal duplications and/or deletions may represent a value above which the maternal CNV is likely to affect a fetal chromosomal abnormality call, resulting in a potential false-positive or false-negative call. As described in greater detail above, the threshold CNV lengths for deletions and/or duplications may be used to trigger follow-up testing, review (e.g., computer-assisted manual review), and/or correction or adjustment of positive and/or negative aneuploidy calls to identify potential false-positive and/or false-negative fetal chromosomal abnormality calls during cfDNA-based noninvasive prenatal screening.

### Example 2

### Adjustment of CNV Regions

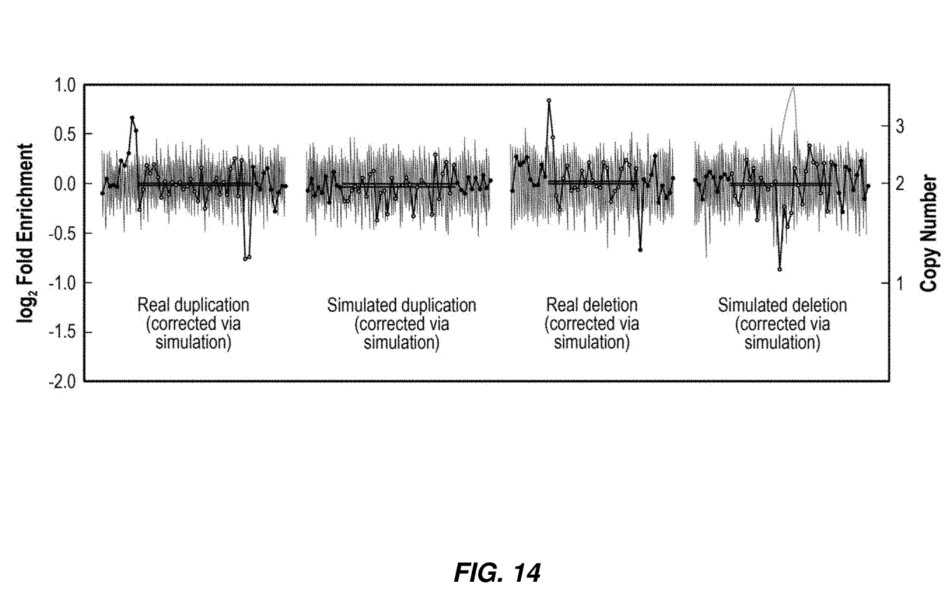

FIG. 14 shows a plot for various exemplary real and synthetic CNV regions in which copy number data based on read count data has been adjusted in accordance with systems and methods described herein. The CNV regions shown in FIG. 14 correspond to CNV regions shown in FIG. 8. The CNV regions shown in FIG. 14 have each been adjusted in comparison with the corresponding CNV regions shown in FIG. 8 so as to reduce potential impacts of the respective CNVs on a fetal chromosomal abnormality call. The copy number variants shown in FIG. 14 include an adjusted real duplication and an adjusted real deletion that have been adjusted to reflect a copy number of 2. Additionally, the illustrated copy number variants include an adjusted synthetic duplication and an adjusted synthetic deletion that have been adjusted to reflect a copy number of 2. The plot in FIG. 14 includes sequencing read counts for a plurality of bins corresponding to the respective chromosome regions, with the left Y-axis of the plot showing loge fold enrichment and the right Y-axis showing the corresponding copy number (log-scale axis).

### Example 3

### Aneuploidy Caller Comparison

To determine which algorithmic features in a noninvasive prenatal screening pipeline minimize the effect of mCNVs on z-scores, various analysis approaches were used to collectively analyze numerous synthetic sequencing datasets generated in accordance with systems and methods described herein. Six different analysis strategies were used to calculate aneuploidy z-scores for synthetic sequencing datasets each including sequencing data representing various maternal duplications in chromosome 13, 18, or 21.

For each of chromosomes 13, 18, and 21, at least 10,000 mCNV-harboring samples were simulated, each using as a baseline a randomly chosen sample shown to be both euploid (via the “mCNV filtering” analysis strategy described below) and void of mCNVs. Most samples (83%) were chosen for exactly one round of simulation, with the rest used in several rounds of simulations (15% in two and 2% in 3 or more simulations). The sizes of the mCNVs were selected to span a logarithmic range, and the position of each mCNV was randomly chosen. The mCNV size values used in downstream analyses were based on algorithm-detected boundaries rather than the simulated boundaries (e.g., a 3 Mb simulated duplication identified as being 2.8 Mb by the mCNV-finding algorithm is represented in the plots and associated analyses herein based on the 2.8 Mb size).

To calculate the specificity of each analysis strategy as a function of mCNV size, the z-score of a euploid sample harboring an mCNV was modeled as a random variable Z=Z_{mCNV-}+ΔZ_{dup}. Z_{mCNV-} represents the z-score of a sample without an mCNV. It follows a standard normal distribution N(μ=0, σ=1) and is not a function of mCNV size. By contrast, for an mCNV of size s, ΔZ_{dup} is normally distributed with mean μ_{dup} and standard deviation σ_{dup} calculated from the ΔZ_{dup} values of the 200 simulated samples whose mCNV sizes were closest to s. Assuming Z_{mCNV-} and ΔZ_{dup} are independent, Z is a normal random variable with mean μ_{dup} and standard deviation (1+σ_{dup}²)^{0.5}. Since the simulations introduced mCNVs into otherwise euploid samples, any modeled positives (i.e., Z=Z_{mCNv-}+ΔZ_{dup}>3) were false positives. Furthermore, any modeled samples with Z_{mCNV-}>3 were considered to be statistical false positives. Hence, the false-positive rate (FPR) attributable to mCNVs was calculated by omitting these statistical false positives:

FPR_{mCNV}=P(Z_{mCNV}+ΔZ_{dup}>3)−P(Z_{mCNV}>3)

Specificity was calculated as 1−FPR_{mCNV}. The specificity as a function of mCNV size was estimated for each chromosome separately using simulated samples with mCNVs introduced on the chromosome of interest.

As a first step toward measuring the impact of mCNVs on noninvasive prenatal screening performance, mCNV frequency, size, and positional bias was surveyed in the 87,255 patient samples. Using a rolling-window z-score algorithm, mCNVs ≥200 kb were identified. On average, patients had 1.07 autosomal mCNVs, and 65% of patients had at least one mCNV. There were 37% more deletions than duplications overall, but duplications were generally larger than deletions (median sizes 360 kb and 260 kb, respectively; Kruskal-Wallis H-test p<0.05).

Chromosomes 13, 18, and 21 are commonly tested in noninvasive prenatal screening, and mCNVs on these chromosomes may pose the most direct risk for false positives. On these chromosomes, 2.1% of all patients had at least one duplication and 2.5% had at least one deletion with 4.5% having an mCNV of either type (see, e.g., FIG. 2A). On chromosome 21, deletions and duplications were observed at a similar frequency, yet mCNVs larger than 1 Mb were all duplications (21 duplications and no deletions; see, e.g., FIGS. 2B-C). The high frequency of mCNVs on the commonly trisomic chromosomes suggests that noninvasive prenatal screening strategies that result in no-calls for samples with mCNVs might be clinically inviable, as the rate of no-calls and invasive follow-up procedures might be unacceptably frequent.

The positional distribution of mCNVs was investigated to evaluate whether, if mCNV positions were highly predictable, an algorithm could achieve robustness simply by masking out (or “blacklisting”) such regions. It was observed that mCNVs were not distributed uniformly (see, e.g., FIG. 2D). Hotspots of mCNVs were common, with some hotspots having an equal number of duplications and deletions, and others having an imbalanced ratio of the two. However, mCNVs were not constrained to hotspot regions, as they were observed across nearly all of the mappable portion of chromosome 21, with only about 14% of the chromosome having no observed mCNVs (approximately 7% of chromosome 13 and 9% of chromosome 18 did not have mCNVs). Though mCNV hotspots suggest that a blacklist approach could partially mitigate the impact of mCNVs, this strategy may have drawbacks: either (1) many sites may be blacklisted, which would impair sensitivity for aneuploidy detection or (2) few sites may be blacklisted, after which many samples would retain mCNVs within the analyzed regions that could lower specificity. This result may extend to noninvasive prenatal screening assays that apply the blacklist at a biochemical level, e.g., by only targeting certain regions for sequencing.

The impact of mCNVs on aneuploidy-calling fidelity as a function of mCNV size was next explored. Empirically observed mCNVs rarely spanned ≥1% of a chromosome, which prohibited a statistically powered assessment of the impact of these large mCNVs. To overcome the sparsity of empirical data, simulations to systematically analyze the effects of maternal duplications on trisomy detection were implemented. To create a simulated sample harboring an mCNV of a given size and position, the bin-level copy-number data corresponding to the region of interest was scaled by an empirically derived factor in a euploid and mCNV-free sample. Simulated samples strongly resembled their observed counterparts, both at the level of bin profile and the distribution of bin copy-number values. The bin copy number within simulated mCNVs was very slightly overdispersed compared to the bin copy numbers within detected patient mCNVs. The strong overlap between median z-scores for the empirical and simulated samples (see, e.g., FIG. 13) suggests that this dilation effect may have a negligible impact on our results.

Maternal duplications have been observed to exert an upward pressure on z-scores, and this effect was reproduced in the simulated data on autosomes (see, e.g., FIG. 13). Importantly, with the simulated data the effect was more readily observed, as the full size spectrum of potential mCNVs was modeled. Larger simulated duplications exhibited increasing positive shifts away from the expected median z-score of 0 for a euploid sample (see, e.g., FIG. 13). In noninvasive prenatal screening pipelines, this bias toward higher z-scores may contribute to false positives and lower specificity. The simulations suggested, for example, that a sample harboring an mCNV spanning 3.0% or more of a chromosome may be expected to yield a false positive using the “Simple” analysis strategy (e.g., where the median z-score exceeds 3) described below.

FIGS. 15A-15F illustrate the respective performance of each of the six algorithmic analysis strategies, as determined by analyzing the synthetic sequencing datasets using the analysis strategies to determine impacts and/or potential impacts of maternal duplications in chromosome 21 on aneuploidy calls. At least 10,000 simulated samples were evaluated for each test of an analysis strategy. The synthetic samples each had both a “pre-mCNV” z-score (reflecting their original status as both euploid and free of mCNVs) and a “post-mCNV” z-score calculated after introducing a modeled (i.e., simulated) maternal duplication. The difference between the post- and pre-mCNV z-scores, ΔZ_{dup}, is a direct measure of the effect of mCNVs on corresponding z-scores. A positive ΔZ_{dup} means the aneuploidy z-score was increased with the introduction of a simulated mCNV. For each of the six analysis strategies, ΔZ_{dup} was plotted as a function of mCNV size (left panels of FIGS. 15A-15F), and these data were sampled to estimate how specificity falls as mCNVs grow (right panels of FIGS. 15A-15F). The six strategies differed both in their approaches for calculating the central tendency (e.g., mean or median) and dispersion of bin copy-number values across a chromosome and in their filtering methods that determine which bins are used in those calculations, as summarized in Table 1.

TABLE 1
Summary of six algorithmic analysis strategies tested

| | Measure | | |
|---|---|---|---|
| | of | | |
| Strategy | Ceniral | Measure of | |
| Name | tendency | dispersion | Outlier exclusions/Notes |
| Simple | Mean | Raw standard | None |
| | | deviation | |
| Robust | Median | Standard deviation | None |
| | | estimated from IQR | |
| Robust + | Median | Standard deviation | Excludes bin copy-number |
| Gaussian | | estimated from IQR | values more than four |
| | | | standard deviations from a |
| | | | Gaussian fit |
| Z-correction | Median | Standard deviation | Corrects z-score using a |
| | | estimated from IQR | size- and chromosome- |
| | | | specific offset based on |
| | | | simulations |
| Value | Median | Standard deviation | Excludes bin copy-number |
| filtering | | estimated from IQR | values less than 1.5 or more |
| | | | than 2.5 |
| mCNV | Median | Standard deviation | Excludes bins determined |
| filtering | | estimated from IQR | to be within an mCNV |

(IQR = interquartile range).

An estimate of cumulative false positives due to mCNVs per 100,000 was calculated as the weighted sum of the empirical maternal-duplication size-prevalence data (see, e.g., FIG. 2B) multiplied by the size-dependent specificity data from the simulation-based analysis (see, e.g., FIGS. 15A-F, right column). The “Simple” analysis strategy (FIG. 15A) summarized the bin copy-number values of a chromosome by the mean and standard deviation, without applying any mCNV-specific or nonspecific filters. This method was determined to be the most susceptible to false positives due to mCNVs; at the point where duplication size exceeded 1.6% of chromosome 21 (0.52 Mb, autosomal duplications of this size or greater observed in 8.2% of patients), the estimated specificity dropped below 95%, and duplications spanning more than approximately 10% of the chromosome always caused false positive results. Analysis strategies using an alternative to the z-score while still using the mean and standard deviation in the analysis—such as employing a t-test—may be similarly susceptible to mCNVs.

The “Robust” analysis strategy (FIG. 15B) improved upon the “Simple” analysis strategy by replacing the mean with the median and estimating the standard deviation of bin copy-number values from their interquartile range (IQR), rather than calculating the standard deviation directly. The median and IQR may be less susceptible to outlying bins than the mean and standard deviation; therefore, utilizing these values may increase robustness to mCNVs. The “Robust” analysis strategy was determined to have smaller z-score deflections than the “Simple” analysis strategy for mCNVs spanning <10% of the chromosome; however, specificity dropped below 95% for mCNVs spanning ≥3.8% (1.2Mb) of chromosome 21.

The “Robust+Gaussian” analysis strategy (FIG. 15C) added another layer of nonspecific outlier removal to the “Robust” analysis strategy by rejecting bins falling far outside of a Gaussian fit to the bin copy-number data. Performance of the “Robust+Gaussian” analysis strategy was determined to be better than both the “Simple” and “Robust” analysis strategies, but was susceptible to mCNVs spanning approximately 8.8% of chromosome 21 (2.8 Mb), at which point specificity dropped below 95%. As a consequence of more stringent filtering, the “Robust+Gaussian” analysis strategy discarded more bins relative to the “Simple” and “Robust” analysis strategies. Such excess bin culling may reduce sensitivity of whole genome sequencing (WGS)-based noninvasive prenatal screening since sensitivity may be an increasing function of the number of bins.

The “Z-correction” analysis strategy (FIG. 15D) first calculated a z-score for the chromosome—without removal of mCNV bins—and next subtracted a chromosome- and size-specific z-score offset determined via simulated samples analyzed with the “Robust” analysis strategy. In adjusting for mCNVs, this method assumed that the effect of mCNVs on z-score is determined by size and is reproducible across samples. The “Z-correction” analysis strategy performed better in aggregate compared to the previous approaches, as the median of ΔZ_{dup} remained near 0 even for large duplications. However, ΔZ_{dup} values were relatively highly dispersed for simulated duplications around >3% (1 Mb) in size, meaning that an mCNV would still cause large z-score deviations for some samples. The specificity for chromosome 21 dropped below 95% at duplication sizes of approximately 21% (6.7 Mb).

The “Value filtering” analysis strategy (FIG. 15E) operated on a premise of neutralizing mCNVs by purging bins with high (>2.5) or low (<1.5) copy-number values prior to calculating the chromosome-wide average and dispersion. The “Value filtering” analysis strategy was robust to mCNVs that were not extremely large (<95% specificity for mCNVs larger than 27% of chromosome 21, or 8.7 Mb), but showed elevated variability in ΔZ_{dup} for all mCNV sizes relative to other strategies. The increased noise results from filtering out bins too aggressively, leaving fewer data points—and consequently more noise—or z-score calculation. Duplications may be expected to still have some bins with copy-number values less than 2.5 but elevated compared to non-duplicated regions, which may be why large duplications caused a positive ΔZ_{dup}. The “Value filtering” analysis strategy showed the most variability in the fraction of bins retained after filtering compared to all other methods that were analyzed, suggesting that it could have a nontrivial and variable impact on aneuploidy sensitivity for samples with mCNVs, as sensitivity depends on the number of bins available for z-score calculation.

The “mCNV filtering” analysis strategy (FIG. 15F) performed a sample-specific exclusion of bins included in mCNVs. Treating each sample separately, chromosomes were scanned for the presence of mCNVs and then mCNV-spanning bins are excised prior to all downstream calculations. The “mCNV filtering” analysis strategy was the most robust to mCNVs compared to the others, with specificity dropping below 95% only for maternal duplications larger than 58% of chromosome 21 (19 Mb). Because the “mCNV filtering” analysis strategy removed only the data that should be removed, it decreased z-score noise, retained high specificity, and had more consistent sensitivity compared to the “Value filtering” analysis strategy due to less noise in the number of bins retained.

To evaluate the algorithmic strategies through a more clinically relevant lens, the expected frequency of false-positive aneuploidy calls resulting from mCNVs on chromosomes 13, 18, and 21 was evaluated. Using the measured relationship between duplication size and ΔZ_{dup} (see FIG. 13), as well as the size and chromosome of observed maternal duplications in over 56,000 NIPS samples (the 65% of the 87,255 sample cohort with mCNVs), a false-positive rate combined across the three chromosomes for each of the six analysis strategies described earlier (see Table 1) was estimated.

On average, mCNVs have been predicted to cause a false-positive result of trisomy 13, 18, or 21 for 1 in 960 patients using the “Simple” analysis strategy. This false-positive rate is similar to the rates reported by laboratories prior to incorporating changes that mitigate the effect of mCNVs: in outcome studies, Chudova et al. reported 3 mCNV-caused false positives in 1914 patients (a rate of 1 in 640), and Strom et al. reported 61 mCNV-caused false positives in 31,278 patients (a rate of 1 in 510). See Chudova et al., N. Engl. J. Med., vol. 375, pp. 97-98 (2016), and Strom et al., N. Engl. J. Med. vol. 376, pp. 188-189 (2017). The “Simple” analysis strategy estimated false-positive rate is also consistent with aggregate statistics of noninvasive prenatal screening specificity from meta-analyses over the time period when comparable methods were common.

Overall, mCNV-aware analysis strategies (“Z-correction”, “Value filtering”, and “mCNV filtering” analysis strategies) had higher specificity than mCNV-unaware approaches (“Simple”, “Robust”, and “Robust+Gaussian” analysis strategies). All mCNV-aware analysis strategies increased the pooled specificity for the three common trisomies 13, 18, and 21 such that the aggregate false-positive rate was fewer than 1 in 100,000 tests. Remarkably, relative to the “Simple” analysis strategy, with one false positive expected for every 960 samples, the “mCNV filtering” analysis strategy is expected to incur only one mCNV-caused false positive for every 580,000 samples, representing a 600-fold reduction.

### Example 4

### Real CNV Adjustment

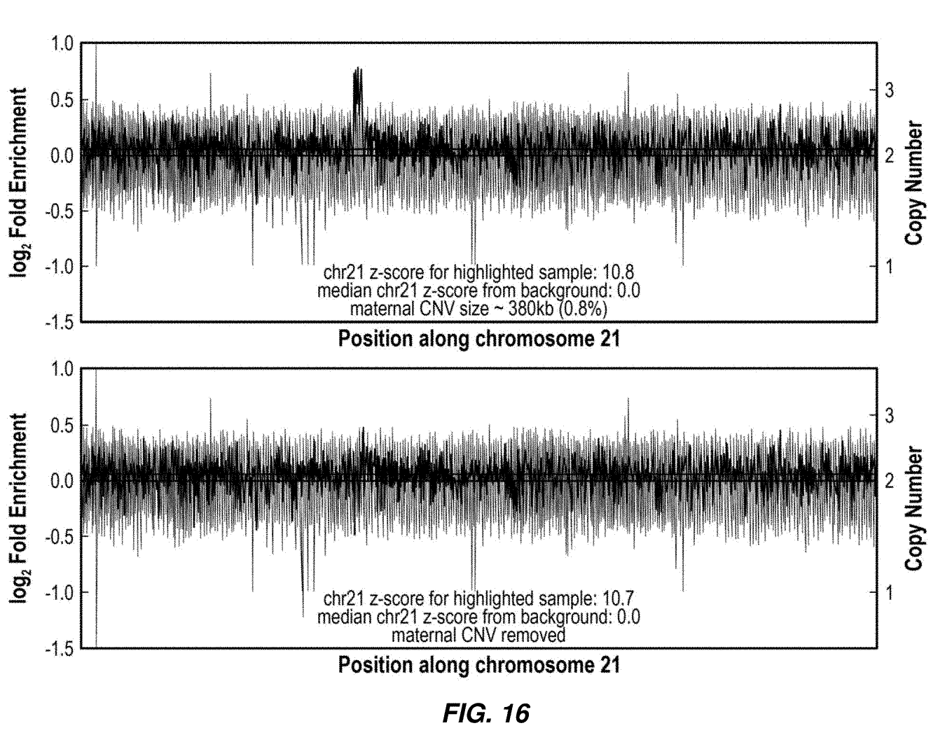

FIG. 16 shows a plot for an exemplary real sequencing dataset for chromosome 21 representing a fetal trisomy-21 and having a maternal CNV region of about 380 kb in size that is adjusted in accordance with systems and methods described herein. The CNV shown in FIG. 16 is a maternal duplication of a portion of chromosome 21. The plot in FIG. 16 includes sequencing read counts for a plurality of bins corresponding to the respective chromosome-21 regions, with the left Y-axis of the plot showing loge fold enrichment and the right Y-axis showing the corresponding copy number (log-scale axis). An aneuploidy call for trisomy-21 does not change following the adjustment of the CNV region since the z-score only changes from 10.8 to 10.7.

### Example 5

### Synthetic CNV Adjustment

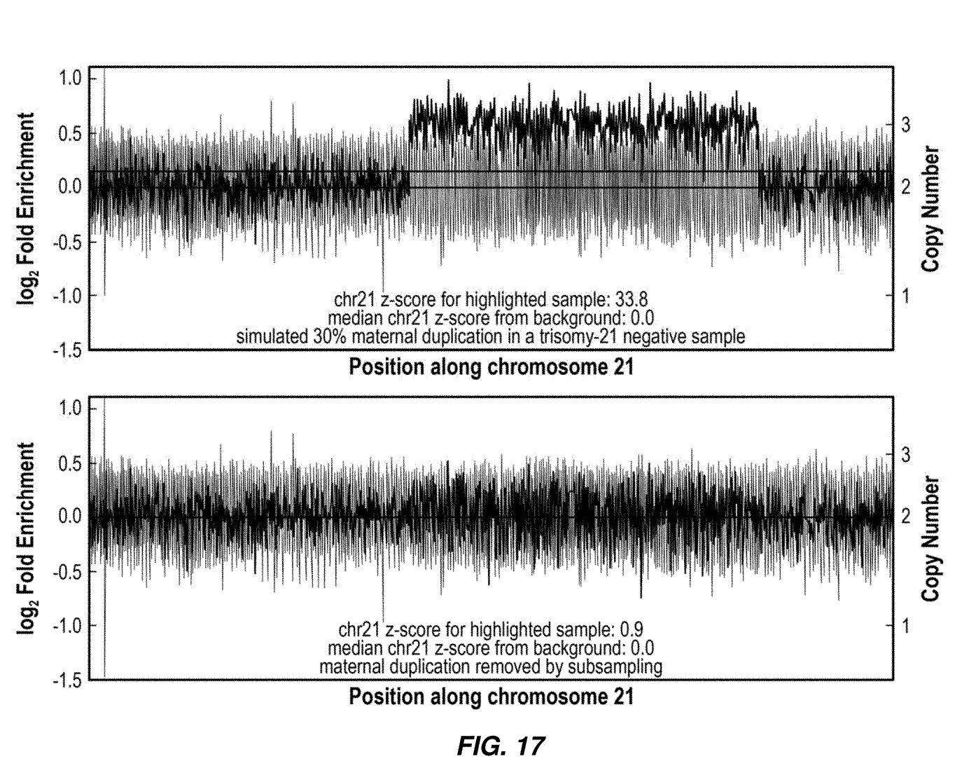

FIG. 17 shows a plot for an exemplary synthetic sequencing dataset for chromosome 21 representing a fetal euploidy and a maternal duplication. As shown in FIG. 17, the exemplary synthetic sequencing dataset includes a synthetic maternal duplication region that covers 30% of chromosome 21 and that is adjusted using subsampling in accordance with systems and methods described herein. The plot in FIG. 17 includes sequencing read counts for a plurality of bins corresponding to the respective chromosome 21 regions, with the left Y-axis of the plot showing loge fold enrichment and the right Y-axis showing the corresponding copy number (log-scale axis). An aneuploidy call for trisomy-21 changes from a positive call to a negative call following the adjustment of the CNV region, with the z-score changing from 33.8 to 0.9.

### Example 6

### Synthetic CNV Adjustment

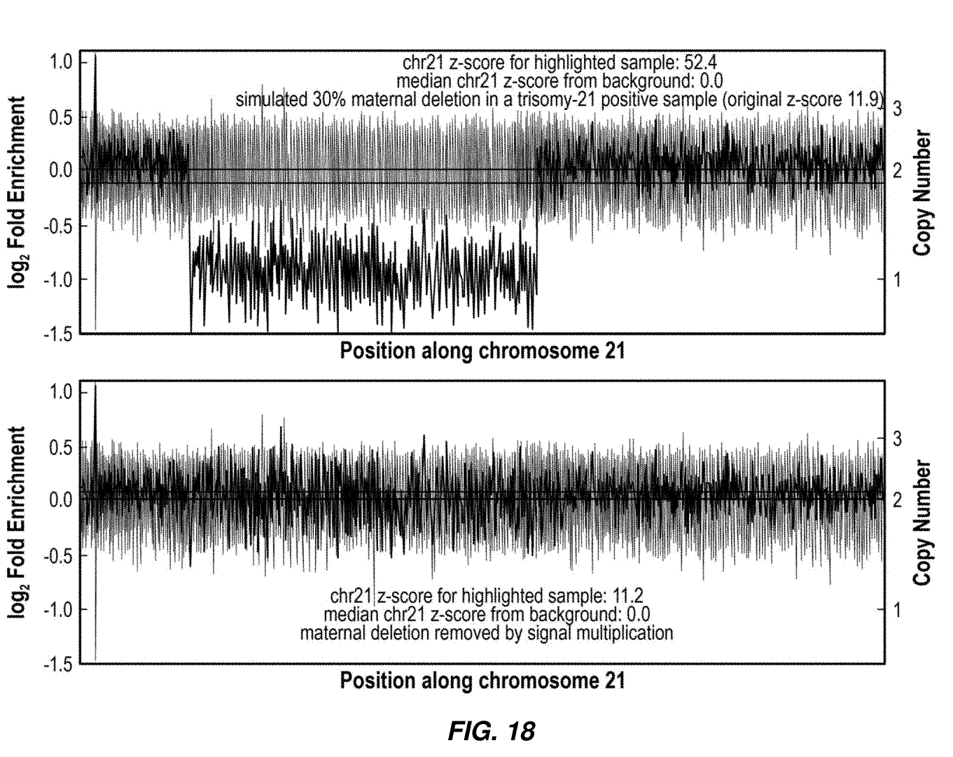

FIG. 18 shows a plot of an exemplary synthetic sequencing dataset for chromosome 21 representing a fetal trisomy-21 and a maternal deletion. As shown in FIG. 18, the exemplary synthetic sequencing dataset includes a synthetic maternal deletion region that covers 30% of chromosome 21 and that is adjusted using signal multiplication in accordance with systems and methods described herein. The plot in FIG. 18 includes sequencing read counts for a plurality of bins corresponding to the respective chromosome 21 regions, with the left Y-axis of the plot showing loge fold enrichment and the right Y-axis showing the corresponding copy number (log-scale axis). An aneuploidy call for trisomy-21 changes from an incorrect monosomy call to a correct trisomy call following the adjustment of the CNV region, with the z-score changing from −52.4 to 11.2.

### Example 7

### Exemplary CNVs Observed in Real cfDNA Samples

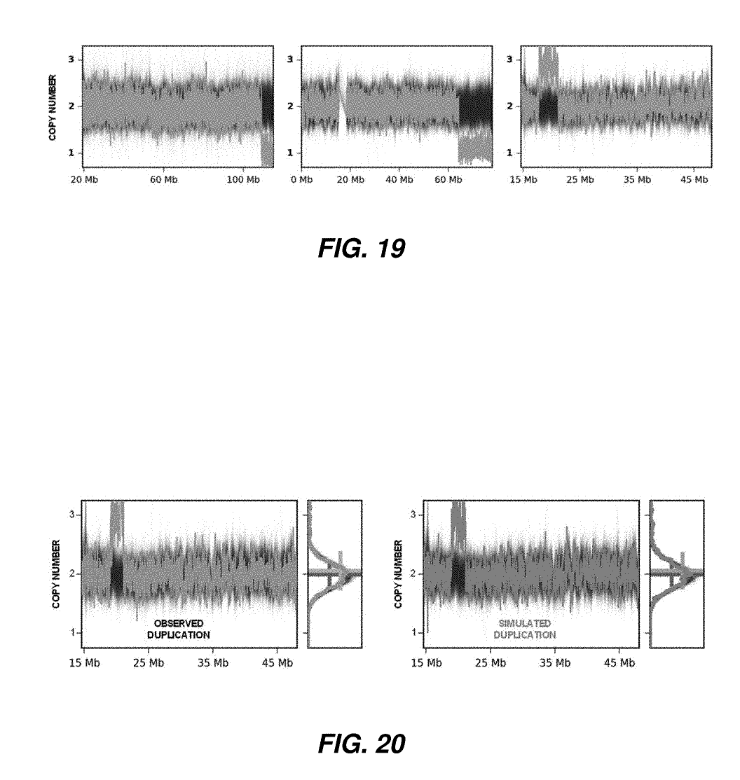

FIG. 19 shows a diagram illustrating exemplary binned sequencing read counts from real cfDNA samples having various maternal copy number variants. FIG. 19 illustrates a 6 Mb deletion on chromosome 13, a 14 Mb deletion on chromosome 18, and a 3 Mb duplication on chromosome 21.

### Example 8

### Real CNV and Synthetic CNV

FIG. 20 shows a diagram illustrating exemplary binned sequencing read counts from a real cfDNA sample having a maternal duplication and exemplary binned sequencing read counts from a synthetic cfDNA sample having a synthetic maternal duplication. As shown in FIG. 20, the synthetic mCNV generated through simulation maintains the noise observed in the real mCNV of the real cfDNA sample.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

While various aspects and embodiments have been disclosed herein, other aspects and embodiments are contemplated. The various aspects and embodiments disclosed herein are for purposes of illustration and are not intended to be limiting. Unless otherwise noted, the terms “a” or “an,” as used in the specification and claims, are to be construed as meaning “at least one of.” In addition, for ease of use, the words “including” and “having,” and variants thereof (e.g., “includes” and “has”) as used in the specification and claims, are interchangeable with and have the same meaning as the word “comprising” and variants thereof (e.g., “comprise” and “comprises”).

1. A computer-implemented method for optimizing performance of a deoxyribonucleic acid (DNA)-based noninvasive prenatal screen, at least a portion of the method being performed by a computing device comprising at least one processor, the method comprising:
generating a plurality of synthetic sequencing datasets, each of the plurality of synthetic sequencing datasets representing genetic sequencing data from a sample comprising maternal and fetal cell-free DNA (cfDNA), by, for each of the plurality of synthetic sequencing datasets:
generating at least one of a plurality of synthetic copy number variants comprising a synthetic number of copies of at least a portion of a region of interest represented by a synthetic number of sequencing reads from one or more segments within the region of interest; and
modifying a real sequencing dataset, which includes genetic sequencing data from a real test sample comprising maternal and fetal cfDNA, by replacing a number of real sequencing reads from the one or more segments within the region of interest in the real test sample with the synthetic number of sequencing reads; and
calculating a potential impact of each of the plurality of synthetic copy number variants on a fetal chromosomal abnormality call during DNA-based noninvasive prenatal screening based on the plurality of synthetic sequencing datasets.

2-39. (canceled)

40. A method for performing a DNA-based noninvasive prenatal screen on a sample that includes maternal DNA and fetal DNA, the method comprising:
isolating cfDNA fragments from a sample that includes maternal cfDNA and fetal cfDNA;
sequencing each of the cfDNA fragments to obtain a plurality of fragment sequencing reads;
identifying target sequencing reads of the plurality of fragment sequencing reads, the identified target sequencing reads being mappable to specified locations of a reference genome;
determining, out of the identified target sequencing reads, a quantity of target sequencing reads for a region of interest;
calculating a statistical z-score for the region of interest based on the quantity of target sequencing reads for the region of interest;
determining whether the calculated statistical z-score for the region of interest is outside of a predetermined z-score range, a calculated statistical z-score outside of the predetermined z-score range representing a positive call for a fetal chromosomal abnormality in the region of interest of the fetal DNA;
determining whether maternal genomic DNA from the individual includes at least one copy number variant; and
determining, when the maternal genomic DNA from the individual is determined to include at least one copy number variant, whether a feature value of the at least one copy number variant is greater than a threshold feature value, a feature value greater than the threshold feature value indicating that a call for the fetal chromosomal abnormality is likely a false call.

41-65. (canceled)

66. A method for performing a DNA-based noninvasive prenatal screen on a sample that includes maternal DNA and fetal DNA, the method comprising:
isolating cfDNA fragments from a sample that includes maternal cfDNA and fetal cfDNA;
sequencing each of the cfDNA fragments to obtain a plurality of fragment sequencing reads;
identifying target sequencing reads of the plurality of fragment sequencing reads, the identified target sequencing reads being mappable to specified locations of a reference genome;
analyzing the identified target sequencing reads to determine whether maternal genomic DNA from the individual includes at least one copy number variant;
adjusting, when the maternal genomic DNA from the individual is determined to include at least one copy number variant, a quantity of target sequencing reads of the identified target sequencing reads for at least one variant region corresponding to the at least one copy number variant to generate an adjusted set of target sequencing reads;
determining, out of the identified target sequencing reads, a quantity of target sequencing reads for a region of interest;
generating an adjusted quantity of target sequencing reads for the region of interest based on the adjusted set of target sequencing reads;
calculating a statistical z-score for the region of interest based on the adjusted quantity of target sequencing reads for the region of interest; and
determining whether the calculated statistical z-score for the region of interest is outside of a predetermined z-score range, a calculated statistical z-score outside of the predetermined z-score range representing a positive call for a fetal chromosomal abnormality in the region of interest of the fetal DNA.

67. The method of claim 66, wherein generating the adjusted quantity of target sequencing reads for the region of interest comprises replacing sequencing reads of the quantity of target sequencing reads in the at least one variant region with the adjusted set of target sequencing reads.

68. The method of claim 66, wherein adjusting the quantity of target sequencing reads in the at least one variant region to generate the adjusted set of target sequencing reads comprises increasing the number of target sequencing reads in the at least one variant region.

69. The method of claim 66, wherein adjusting the quantity of target sequencing reads in the at least one variant region to generate the adjusted set of target sequencing reads comprises decreasing the number of target sequencing reads in the at least one variant region.

70. The method of claim 66, wherein adjusting the quantity of target sequencing reads in the at least one variant region to generate the adjusted set of target sequencing reads comprises removing target sequencing reads in the at least one variant region.

71. The method of claim 66, wherein determining the quantity of target sequencing reads for the region of interest comprises determining a number of target sequencing reads in each of a plurality of bins corresponding to the region of interest.

72. The method of claim 71, wherein calculating the statistical z-score for the region of interest based on the adjusted quantity of target sequencing reads for the region of interest comprises calculating the statistical z-score for the region of interest based on the average number of target sequencing reads per bin for the plurality of bins corresponding to the region of interest.

73. The method of claim 66, further comprising determining, when the maternal genomic DNA from the individual is determined to include the at least one copy number variant, whether a feature value of the at least one copy number variant is greater than a threshold feature value, a feature value greater than the threshold feature value indicating that a call for the fetal chromosomal abnormality is likely a false call.

74. The method of claim 73, wherein the threshold feature value comprises a threshold percentage of a chromosome covered by the at least one copy number variant.

75. The method of claim 73, wherein the threshold feature value comprises a threshold base pair length of the at least one copy number variant.

76. The method of claim 73, wherein the threshold feature value is determined based on analysis of a plurality of synthetic sequencing datasets each representing genetic sequencing data, each of the plurality of synthetic sequencing datasets being generated by:
generating at least one of a plurality of synthetic copy number variants comprising a synthetic number of copies of at least a portion of a specified region of interest represented by a synthetic number of sequencing reads from one or more segments within the specified region of interest; and
modifying a real sequencing dataset that includes genetic sequencing data of a real test sample by replacing a number of real sequencing reads from the one or more segments within the specified region of interest in the real test sample with the synthetic number of sequencing reads.

77. The method of claim 76, wherein the threshold feature value is further determined by calculating a potential impact of each of the plurality of synthetic copy number variants on a fetal chromosomal abnormality call during DNA-based noninvasive prenatal screening based on the plurality of synthetic sequencing datasets.

78. The method of claim 66, wherein the fetal chromosomal abnormality comprises a chromosomal aneuploidy.

79. The method of claim 66, wherein the fetal chromosomal abnormality comprises at least one of a chromosomal microdeletion and a chromosomal microduplication.

80. The method of claim 66, wherein the at least one copy number variant comprises at least one of a deletion and a duplication.

81. The method of claim 66, wherein the region of interest comprises a chromosome or a selected portion of a chromosome.

82. The method of claim 66, wherein the region of interest and the at least one copy number variant are located in the same chromosome.

83. The method of claim 66, wherein the region of interest and the at least one copy number variant are located in different chromosomes.
